(19) United States
(12) Patent Application Publication
(10) Pub. No.: US 2024/0255825 A1
(43) Pub. Date: Aug. 1, 2024

(54) Smart Glass Power Reuse

(71) Applicant: SAGE Electrochromics, Inc., Faribault, MN (US)

(72) Inventors: David Ryan Buszmann, Elko New Market, MN (US); Bryan D. Greer, Northfield, MN (US)

(73) Assignee: SAGE Electrochromics, Inc., Faribault, MN (US)

(21) Appl. No.: 18/420,592

(22) Filed: Jan. 23, 2024

Related U.S. Application Data
(60) Provisional application No. 63/482,543, filed on Jan. 31, 2023.

(51) Int. Cl. G02F 1/163; G02F 1/155; H02M 3/158

(52) U.S. Cl. CPC G02F 1/163; G02F 1/155; H02M 3/1582

(57) ABSTRACT

A system for reusing power from a smart glass is provided. The system includes a power storage device. The system also includes a synchronous converter configured to change a voltage of electrical power. The system further includes a smart glass in electrical communication with the power storage device, the synchronous converter, and a controller. The smart glass is configured to change or maintain a tint in response to a voltage. In addition, the system includes the controller. The controller is configured to receive an indication that the smart glass is to change a tint. The smart glass has a non-zero voltage between two electrical connections. The controller is configured to change, using the synchronous converter, the voltage from the smart glass to a different voltage. The controller is configured to apply the changed voltage to the power storage device to transfer electrical energy for storage and smart glass tinting.

### PRIORITY APPLICATION

This application claims benefit of priority to U.S. Provisional Application Ser. No. 63/482,543, entitled “Smart Glass Power Reuse,” filed Jan. 31, 2023, and which is hereby incorporated herein by reference in its entirety.

### FIELD OF THE DISCLOSURE

The present disclosure is directed to a smart glass system, and more specifically for reuse of power that is used to control a tint of the smart glass.

### BACKGROUND

Smart glass may be used to decrease heat transfer through a window and/or reduce the transmission of visible light to provide tinting or shading. A smart glass system including a smart glass (e.g., an electrochromic (EC) device, an electrochromic insulated glass unit (EC-IGU), an electrochromic glass unit (EC-GU), a device with a glass that changes, for example tint, in response to an input, an electrical charge, and/or the environment) may be used to provide a decrease in thermal conductivity (e.g., increase in insulation) through a transparent substrate and a reduction in visible light transmission through a transparent substrate (e.g., a window or glass pane). An EC device may include EC materials that are known to change their optical properties, such as coloration, in response to the application of an electrical potential, thereby making the transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied. Power used to control a tint of a smart glass may utilize a significant amount of available power from one or more power sources causing increase cost and limiting power for other and/or additional functions.

### SUMMARY

A system for reusing power from a smart glass is provided. The system may include a power storage device, one or more synchronous converters or synchronization converters each configured to change a voltage of electrical power. The system may also include a smart glass in electrical communication with the power storage device, the synchronous converter, and a controller. The smart glass is configured to change or maintain a tint in response a voltage. The controller may be configured to receive an indication that the smart glass is to change a tint. The smart glass has a non-zero voltage between two electrical connections. The controller may also be configured to draw the voltage from the smart glass to the synchronous converter and change, using the synchronous converter, the voltage from the smart glass. The controller may further be configured to store the changed voltage in the power storage device for providing subsequent smart glass tinting. In some aspects, the synchronous converter may include at least one of a boost converter, a buck converter, or a buck-boost converter. The system may also include a power source configured to provide the voltage to change or maintain the tint of the smart glass. As such, the controller may also be configured to control the power source to provide electrical power to the smart glass. In some aspects, the synchronous converter may be a first synchronous converter and the system may include a second synchronous converter. The controller may be further configured to communicate or direct the electric power provided by the power source to change a voltage of the electrical power before the electrical power is provided to the smart glass. The second synchronous converter may increase or decrease a voltage of the electrical power provided by the power source before the electrical power is provided to the smart glass.

### BRIEF DESCRIPTION OF THE DRAWINGS

FIG. 1 illustrates a perspective view of an example EC system according to some aspects of this disclosure.

FIG. 2 illustrates a block diagram of an example system according to some aspects of this disclosure.

FIG. 3 illustrates a block diagram of an example system according to some aspects of this disclosure.

FIG. 4 illustrates a block diagram of an example system according to some aspects of this disclosure.

FIG. 5 illustrates a block diagram of an example system according to some aspects of this disclosure.

FIG. 6 illustrates a block diagram of an example system according to some aspects of this disclosure.

FIG. 7 illustrates a block diagram of an example system according to some aspects of this disclosure.

FIG. 8 illustrates a wiring diagram of an example system according to some aspects of this disclosure.

FIG. 9 illustrates an example method for smart glass power reuse according to some aspects of this disclosure.

FIG. 10 illustrates a wiring diagram of an example system according to some aspects of this disclosure.

FIG. 11 illustrates an example method for smart glass power reuse according to some aspects of this disclosure.

FIG. 12 illustrates a wiring diagram of an example system according to some aspects of this disclosure.

FIG. 13 illustrates an example method for smart glass power reuse according to some aspects of this disclosure.

FIG. 14 illustrates a wiring diagram of an example system according to some aspects of this disclosure.

FIG. 15 illustrates an example method for smart glass power reuse according to some aspects of this disclosure.

FIG. 16 illustrates an example computer system that may be used in some embodiments.

This specification may include references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value. It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will further be understood that the term “or” as used herein refers to and encompasses alternative combinations as well as any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. For example, the words “include,” “including,” and “includes” indicate open-ended relationships and therefore mean including, but not limited to. Similarly, the words “have,” “having,” and “has” also indicate open-ended relationships, and thus mean having, but not limited to.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Whenever a relative term, such as “about”, “substantially” or “approximately”, is used in this specification, such a term should also be construed to also include the exact term. That is, e.g., “substantially straight” should be construed to also include “(exactly) straight”. As used herein, the terms “about”, “substantially”, or “approximately” (and other relative terms) may be interpreted in light of the specification and/or by those having ordinary skill in the art. In some examples, such terms may as much as 1%, 3%, 5%, 7%, or 10% different from the respective exact term.

While embodiments are described herein by way of example for several embodiments and illustrative drawings, those skilled in the art will recognize that the embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. Any headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must).

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

Systems for reusing power from a smart glass are described herein. Smart glass may be used to decrease heat transfer through a window and/or reduce the transmission of visible light to provide tinting or shading. A smart glass system including a smart glass (e.g., an electrochromic (EC) device, an electrochromic insulated glass unit (EC-IGU), an electrochromic glass unit (EC-GU) a device with a glass that changes, for example tint, in response to an input, an electrical charge, and/or the environment) may be used to provide a decrease in thermal conductivity (e.g., increase in insulation) through a transparent substrate and a reduction in visible light transmission through a transparent substrate (e.g., a window or glass pane). An EC device may include EC materials that are known to change their optical properties, such as coloration, in response to the application of an electrical potential, thereby making the transparent substrate more or less transparent or more or less reflective. An EC device can also change its optical properties such as optical transmission, absorption, reflectance and/or emittance in a continual but reversible manner on application of voltage. These properties enable the EC device to be used for applications like smart glasses, EC mirrors, EC display devices, and the like. EC glass may include a type of glass or glazing for which light transmission properties of the glass or glazing are altered when electrical power (e.g., voltage/current) is applied to the glass. EC materials may change in opacity (e.g., may changes levels of tinting) when electrical power is applied. Power used to control a tint of a smart glass may utilize a significant amount of available power from one or more power sources causing increase cost and limiting power for other and/or additional functions. Extracting electrical power (e.g., a voltage) from a smart glass (e.g., a tinted smart glass) and storing the electrical power in one or more power storage devices for subsequent reuse (e.g., subsequent smart glass tinting) may reduce costs, reduce overall power consumption, and/or provide additional electrical power for other and/or addition functions. In some aspects, extracting electrical power (e.g., a voltage) from a smart glass (e.g., a tinted smart glass) and storing the electrical power in one or more power storage devices for subsequent reuse (e.g., subsequent smart glass tinting) may enable power usage to fit within power limited system and/or within power limited standards.

Systems for reusing power from a smart glass may include a power storage device and a synchronous converter configured to change a voltage of electrical power. The system may also include a smart glass in electrical communication with the power storage device, the synchronous converter, and a controller. The smart glass is configured to change or maintain a tint in response to a voltage. The controller may be configured to detect or receive an indication that the smart glass is to change a tint. The smart glass may be holding a voltage or has a non-zero voltage between two electrical connections. The controller may also be configured to draw the voltage from the smart glass to the synchronous converter and change, using the synchronous converter, the voltage from the smart glass. The controller may further be configured to apply the changed voltage to the power storage device for providing subsequent smart glass tinting. In some aspects, the synchronous converter may include at least one of a boost converter, a buck converter, or a buck-boost converter. The system may also include a power source configured to provide the voltage to change or maintain the tint of the smart glass. As such, the controller may also be configured to control the power source to provide electrical power to the smart glass. In some aspects, the synchronous converter may be a first synchronous converter and the system may include a second synchronous converter. The controller may be configured to direct the electric power provided by the power source to the second synchronous converter to change a voltage of the electrical power before the electrical power is provided to the smart glass. The second synchronous converter may increase or decrease a voltage of the electrical power provided by the power source before the electrical power is provided to the smart glass.

In some systems utilizing smart glass, no power savings or reuse is implemented. In some aspects, the systems described herein may utilize a smart glass controller (e.g., an electrochromic (EC) controller, a synchronous converter controller) that controls the polarity of the voltage between the smart glass and a power storage device, for example, depending on which voltage is higher and the desired action of tinting or clearing. For example, a smart glass may only deliver power to a power storage device if the voltage of the smart glass is higher than the voltage at the power storage device. As provided herein, one or more synchronous converters (e.g., a buck converter, a boost converter, or a buck-booster converter) may change the voltage from the smart glass and/or from the power storage device for storing power from the smart glass, tinting the smart glass, and clearing the smart glass. Because current is essentially maintained, as power is communicated between the smart glass and the power storage device, the difference in energy may be accounted for due to a different in voltage as power is communicated or directed between the smart glass and the power storage device. Thus, for example, if a smart glass is tinted using 2.0 volts and is cleared using 1.0 volts, then about 50% of the energy used to tint the smart glass may be recovered and stored in the power storage device for subsequent reuse. Thus, as another example, if a smart glass is tinted using 3.0 volts and is cleared using 0.5 volts, then about 17% of the energy used to tint the smart glass may be recovered and stored in the power storage device for subsequent reuse. It should be understood that communicating power may include directing power from one device or entity (e.g., a power source) to another device or entity (e.g., a power drawing device).

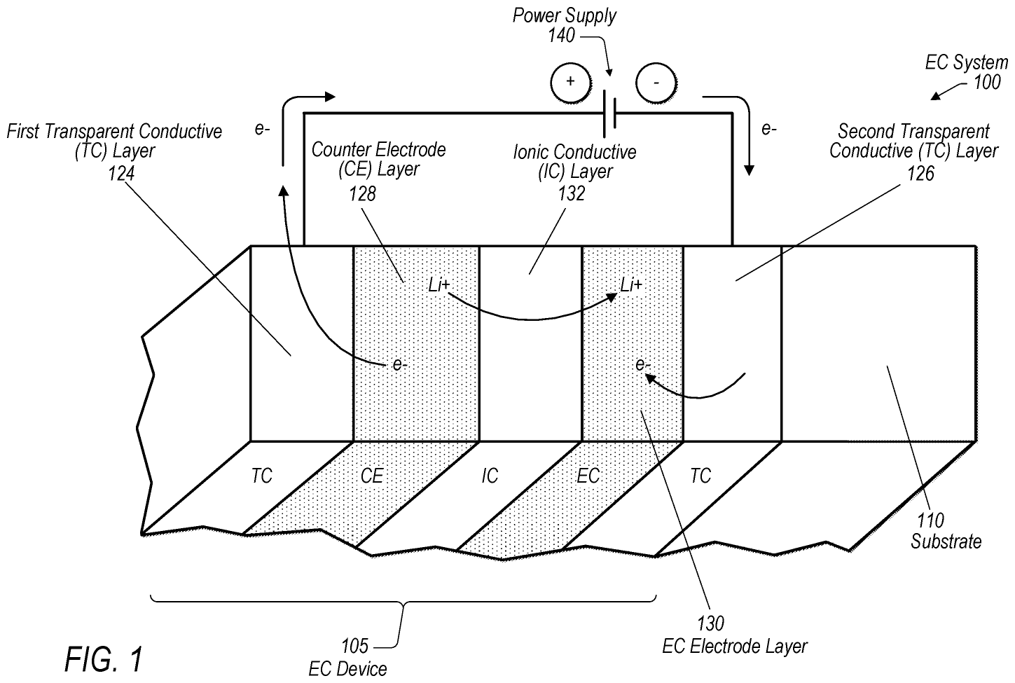

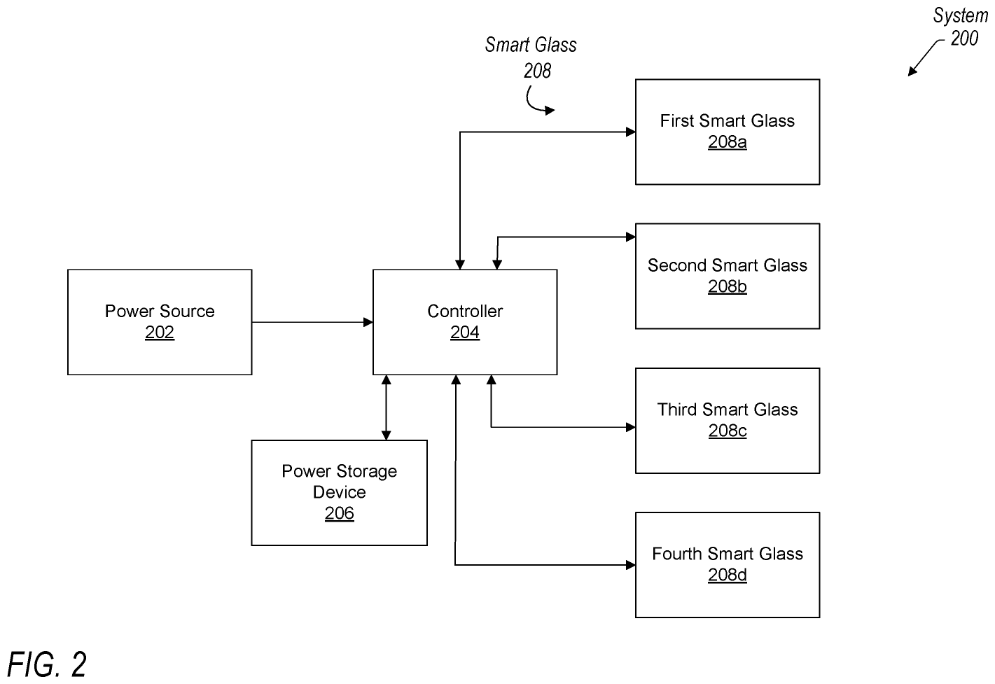

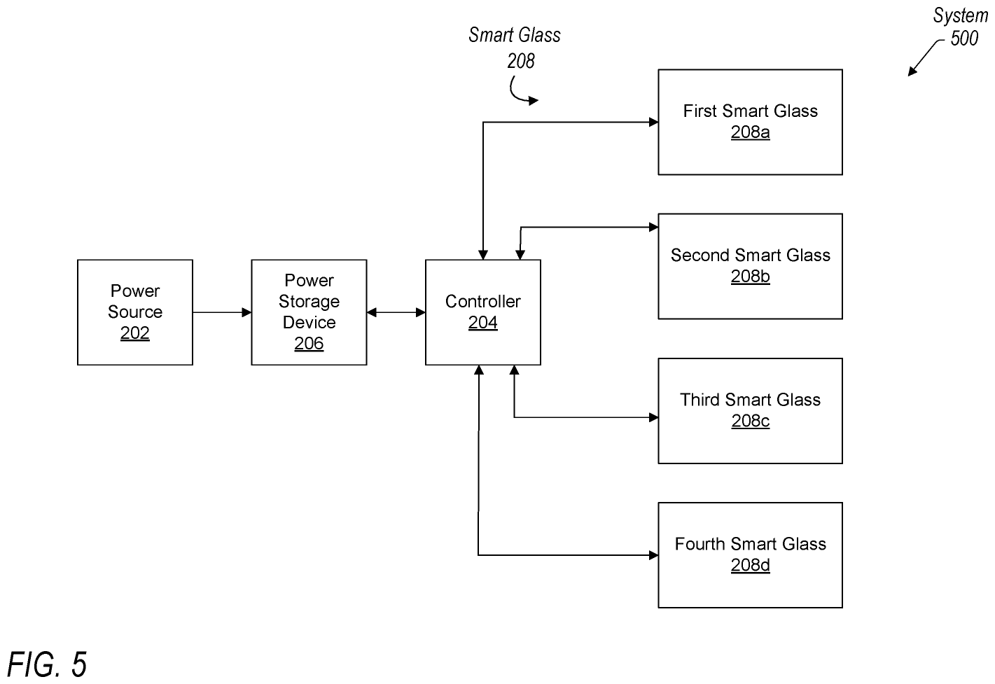

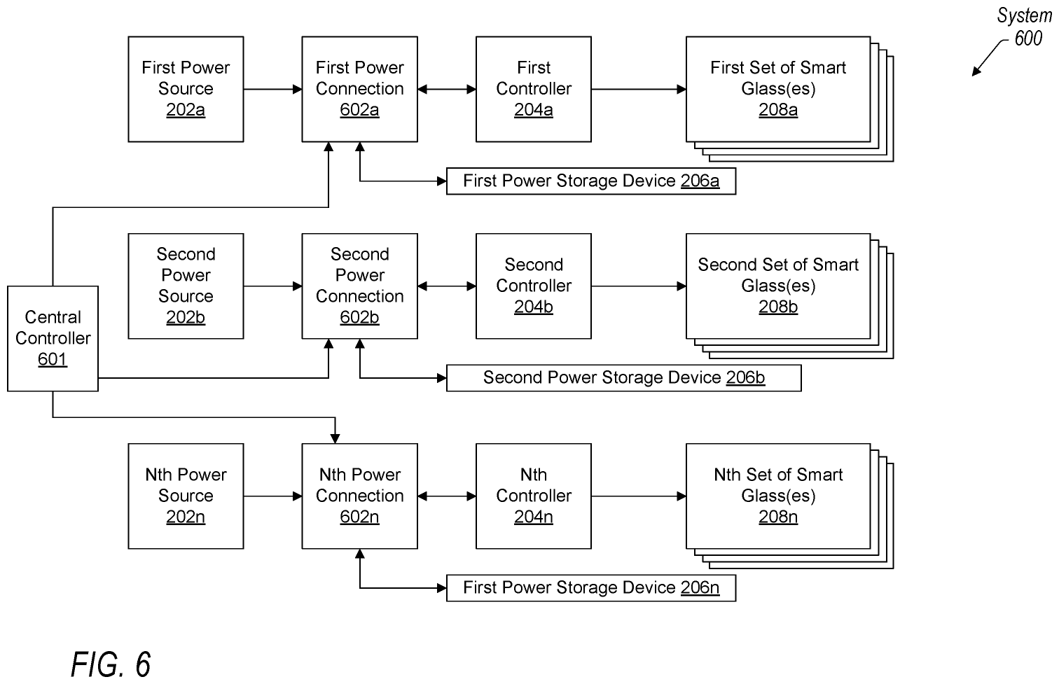

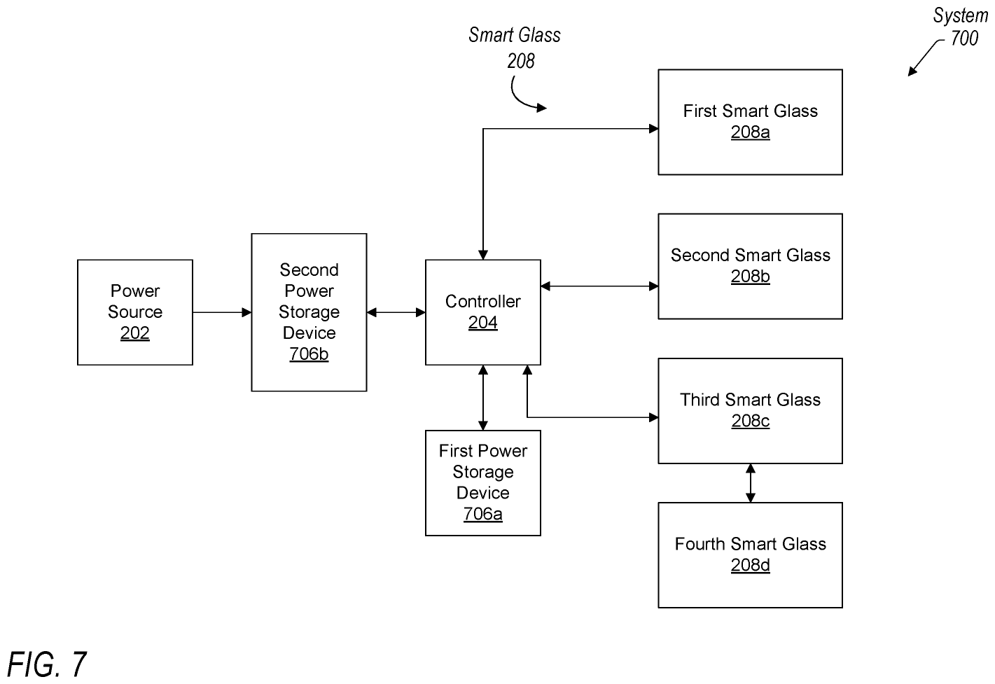

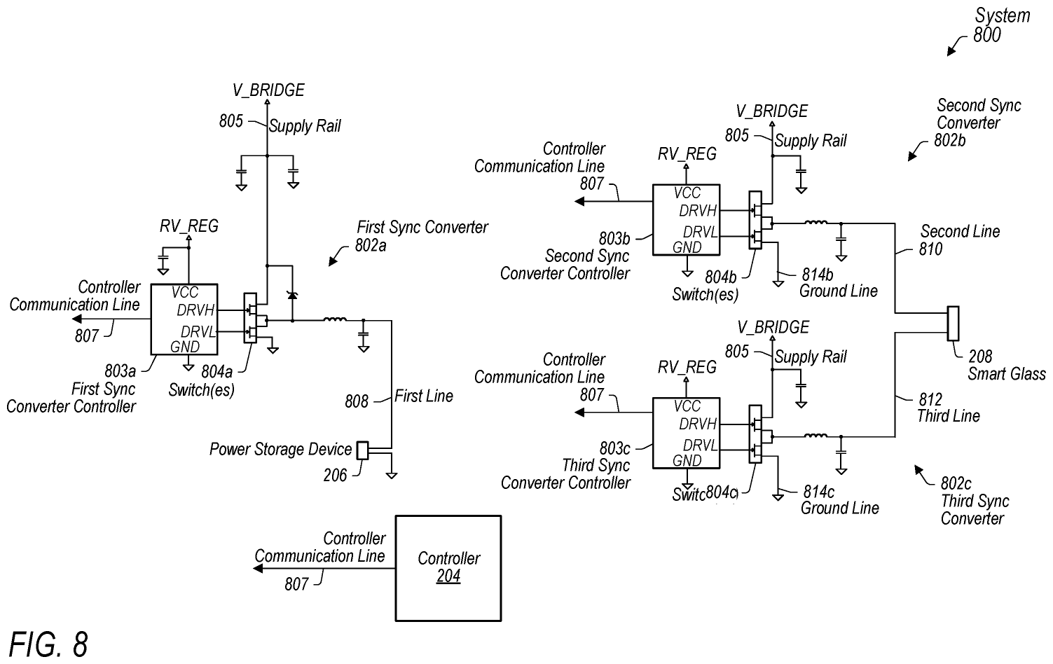

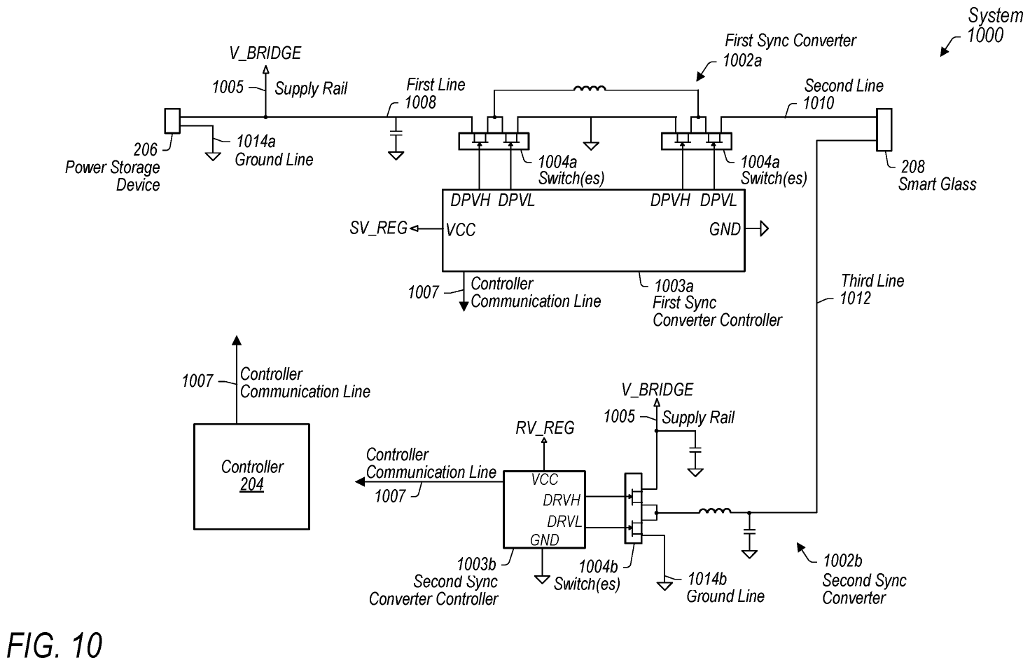

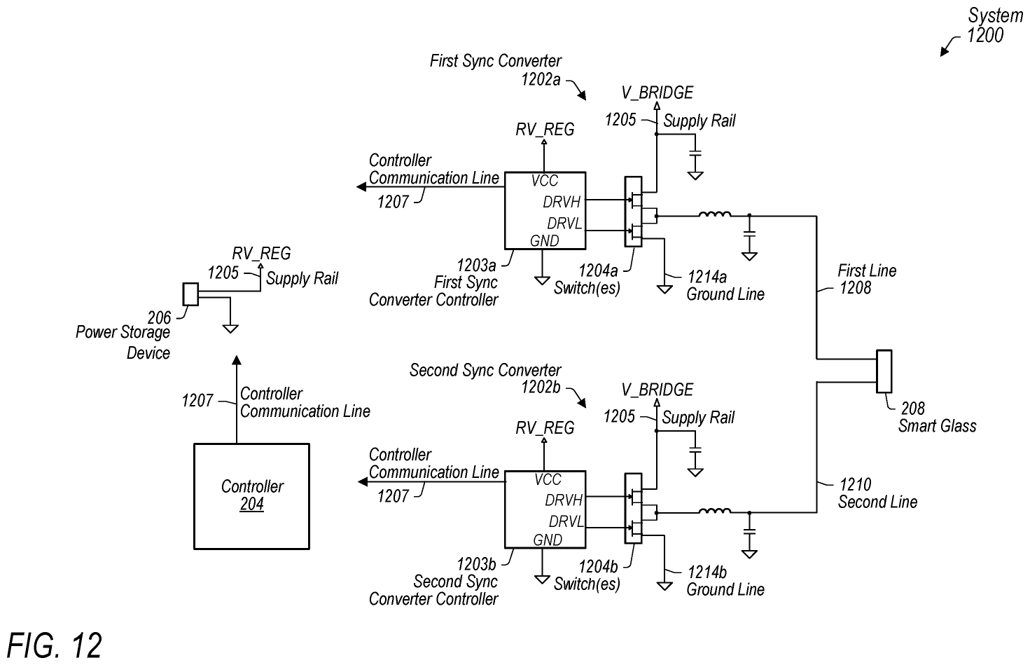

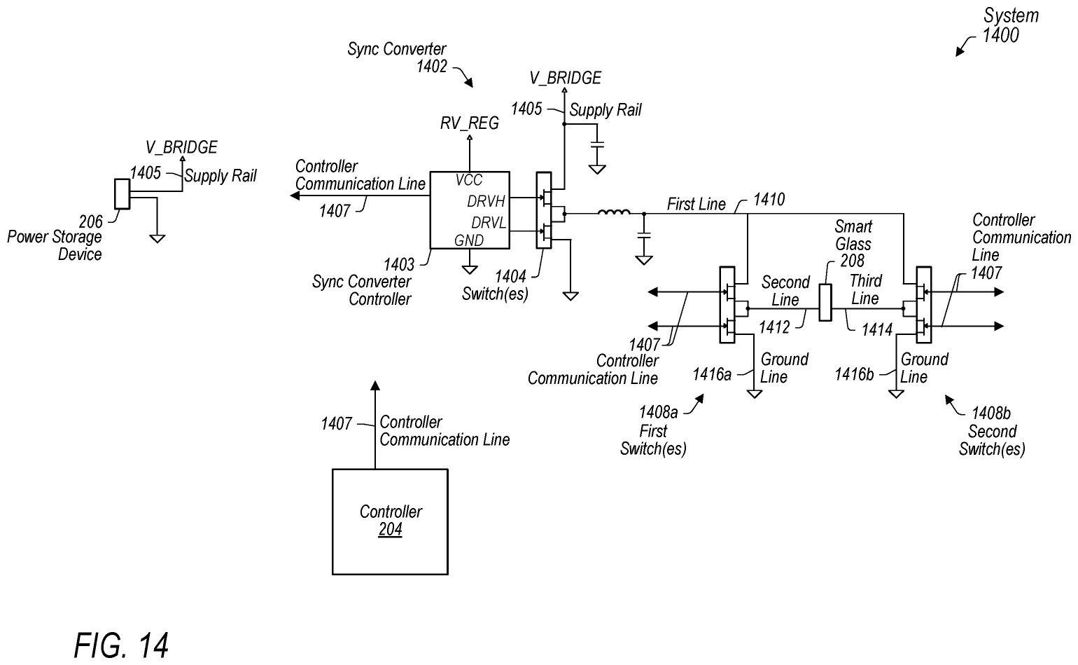

FIG. 1 illustrates a perspective view of an example EC system 100 according to some aspects of this disclosure. The EC system 100 may include one or more same or similar features as the features described with respect to or illustrated in FIGS. 2, 3, 4, 5, 6, 7, 8, 9, 10, 11, 12, 13, 14, 15, and 16. For example, the EC system 100 may be included with and/or may include one or more same or similar features as the system 200 illustrated in FIGS. 2, 3, and 4, the system 500 illustrated in FIG. 5, the system 600 illustrated in FIG. 6, the system 700 illustrated in FIG. 7, the system 800 illustrated in FIG. 8, the system 1000 illustrated in FIG. 10, the system 1200 illustrated in FIG. 12, and the system 1400 illustrated in FIG. 14. FIG. 1, as with the other included figures, is shown for illustrative purposes and does not limit either the possible embodiments of the present invention or the claims. In this example, the EC system 100 may include an EC device 105 secured to a substrate 110. For instance, the EC device 105 may include a thin film which may be deposited on to the substrate 110. The EC device 105 may include a first transparent conductive (TC) layer 124 and a second TC layer 126 in contact with the substrate 110. In some aspects, the first TC layer 124 and the second TC layer 126 may be, or may include, one or more transparent conductive oxide (TCO) layers. The substrate 110 may include one or more optically transparent materials, e.g., glass, plastic, and the like. The EC device 105 may also include a counter electrode (CE) layer 128 in contact with the first TC layer 124, an EC electrode layer 130 in contact with the second TC layer 126, and ionic conductor (IC) layer 132 in-between (e.g., “sandwiched” between) the CE layer 128 and the EC electrode layer 130. The EC system 100 may include a power supply 140 which may provide regulated current or voltage to the EC device 105. Transparency of the EC device 105 may be controlled by regulating density of charges (or lithium ions) in the CE layer 128 and/or the EC electrode layer 130 of the EC device 105. For instance, when the EC system 100 applies a positive voltage from the power supply 140 to the first TC layer 124, lithium ions may be driven across the IC layer 132 and inserted into the EC electrode layer 130. Simultaneously, charge-compensating electrons may be extracted from the CE layer 128, may flow across the external circuit, and may flow into the EC electrode layer 130. Transfer of lithium ions and associated electrons from the CE layer 128 to the EC electrode layer 130 may cause the EC device 105 to become darker—e.g., the visible light transmission of the EC device 105 may decrease. Reversing the voltage polarity may cause the lithium ions and associated charges to return to their original layer, the CE layer 128, and as a result, the EC device 105 may return to a clear state—e.g., the visible light transmission of the EC device 105 may increase.

As described herein, a smart glass or device such as the EC device 105 of FIG. 1 may have a charge (e.g., a voltage) for controlling a tint of the smart glass. For example, an electrical charge may be provided to a smart glass to increase a level of tint (e.g., darken) of the smart glass. As another example, an electrical charge may be provided to a smart glass to maintain a level of tint of the smart glass. As yet another example, an electrical charge may be provided to a smart glass to decrease a level of tint of the smart glass. As another example, an electrical charge may be provided to a smart glass to clear a tint of the smart glass. The electrical charge provided to the smart glass to control a level of tint of the smart glass may be used to charge a power storage device (e.g., a battery) associated with the smart glass.

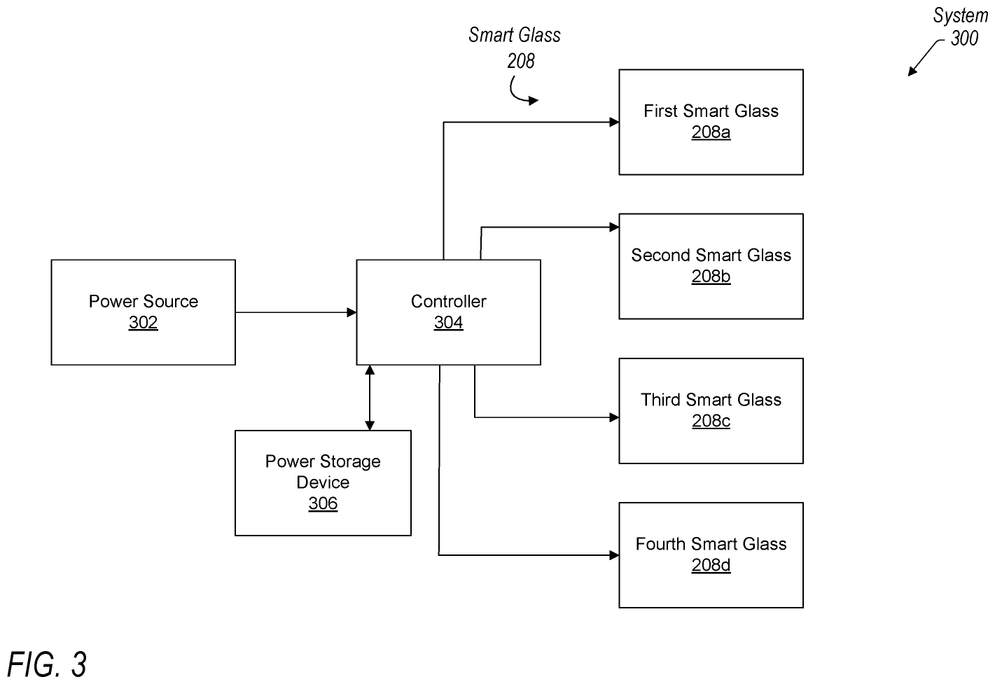

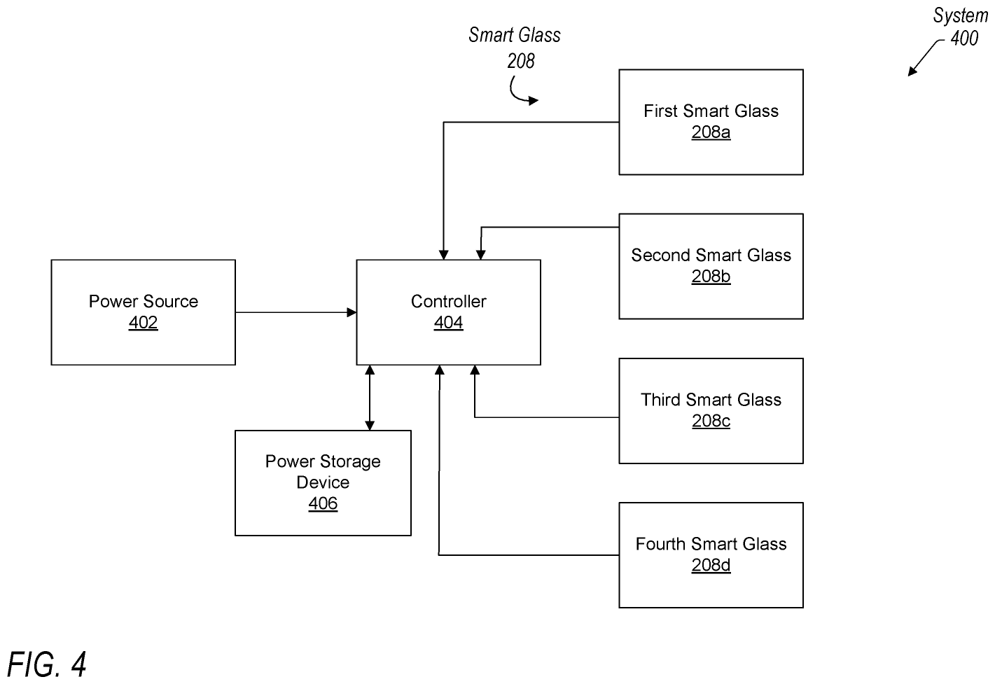

FIG. 2 illustrates a block diagram of an example system 200 according to some aspects of this disclosure. FIG. 3 illustrates a block diagram of an example system 200 according to some aspects of this disclosure. FIG. 4 illustrates a block diagram of an example system 200 according to some aspects of this disclosure. The system 200 may include one or more same or similar features as the features described with respect to or illustrated in FIGS. 1, 5, 6, 7, 8, 9, 10, 11, 12, 13, 14, 15, and 16. For example, the system 200 may include one or more same or similar features as the EC system 100 illustrated in FIG. 1, the system 500 illustrated in FIG. 5, the system 600 illustrated in FIG. 6, the system 700 illustrated in FIG. 7, the system 800 illustrated in FIG. 8, the system 1000 illustrated in FIG. 10, the system 1200 illustrated in FIG. 12, and the system 1400 illustrated in FIG. 14. FIGS. 2, 3, and 4, as with the other included figures, is shown for illustrative purposes and does not limit either the possible embodiments of the present invention or the claims.

As shown in FIG. 2, the system 200 includes a power source 202, a controller 204, a power storage device 206, and a plurality of smart glass 208 including a first smart glass 208a, a second smart glass 208b, a third smart glass 208c, and a fourth smart glass 208d. The power source 202 may be electrically connected to the power storage device 206 via the controller 204. The power source 202 may also be electrically connected to each of the plurality of smart glass 208 via the controller 204. The power storage device 206 may be electrically connected to each of the power source 202 and the plurality of smart glass 208 via the controller 204. In some aspects, the first smart glass 208a, the second smart glass 208b, the third smart glass 208c, and the fourth smart glass 208d may be electrically connected to the controller 204. The power source 202 may include one or more electrical lines providing alternative current (AC) or direct current (DC), an Ethernet cable providing power over the ethernet (POE), one or more solar panels, one or more wireless power receivers (e.g., a transceiver) receiving wireless power from one or more wireless power transmitters (e.g., a transceiver), a combination thereof, or the like. The power storage device 204 may be a battery for storing electrical power. The controller 204 may control power transmission from the power source 202 and may control the distribution and/or transmission of power between the power storage device 204 and each of the plurality of smart glass 208. For example, as shown in FIG. 3, the controller 204 may control power transmission from at least one of the power source 204 or the power storage device 206 and the controller 204 may control power transmission to at least one smart glass of the plurality of smart glass 208. As another example, as shown in FIG. 4, the controller 204 may control power transmission from at least one smart glass of the plurality of smart glass 208 and/or the power source 202 and to the power storage device 206. In some aspects, the controller 204 may control power transmission between each of the plurality of smart glass 208. For instance, the controller 204 may direct a transmission of power from the first smart glass 208a and to at least one of the second smart glass 208b, the third smart glass 208c, or the fourth smart glass 208d. As another instance, the controller 204 may direct a transmission of power from at least one of the first smart glass 208a, the second smart glass 208b, or the third smart glass 208c and to the fourth smart glass 208d.

FIG. 5 illustrates a block diagram of an example system 500 according to some aspects of this disclosure. The system 500 may include one or more same or similar features as the features described with respect to or illustrated in FIGS. 1, 2, 3, 4, 6, 7, 8, 9, 10, 11, 12, 13, 14, 15, and 16. For example, the system 500 may include one or more same or similar features as the EC system 100 illustrated in FIG. 1, the system 200 illustrated in FIGS. 2, 3, and 4, the system 600 illustrated in FIG. 6, the system 700 illustrated in FIG. 7, the system 800 illustrated in FIG. 8, the system 1000 illustrated in FIG. 10, the system 1200 illustrated in FIG. 12, and the system 1400 illustrated in FIG. 14. FIG. 5, as with the other included figures, is shown for illustrative purposes and does not limit either the possible embodiments of the present invention or the claims.

As shown in FIG. 5, the system 500 includes the power source 202, the power storage device 206, the controller 204, and the plurality of smart glass 208 including the first smart glass 208a, the second smart glass 208b, the third smart glass 208c, and the fourth smart glass 208d. The power source 202, the power storage device 206, the controller 204, and the plurality of smart glass 208 may be electrically connected to one another. In some aspects, one or more smart glass of the plurality of smart glass 208 may be electrically connected to the controller 204 in a parallel configuration. Additionally, or alternatively, one or more smart glass of the plurality of smart glass 208 may be electrically connected to the controller 204 in a series configuration. In some aspects, the controller 204 may receive electrical power from the power source 202 via the power storage device 206. In some aspects, the plurality of smart glass 208 may receive electrical power from power storage device 206 via the controller 204. In some aspects, the plurality of smart glass 208 may receive electrical power from power source 202 via the power storage device 206 and the controller 204. The first smart glass 208a, the second smart glass 208b, the third smart glass 208c, and the fourth smart glass 208d may be individually electrically connected to the controller 204.

The controller 204 may control power transmission from the power source 202 and/or the power storage device 206 and may control the distribution and/or transmission of power between the power source 202, the power storage device 204, and/or each of the plurality of smart glass 208. For example, the power source 202 may provide electrical power to the power storage device 206. In some aspects, the controller 204 may direct or control the power storage device 206 to receive electrical power from the power source 202. For instance, the controller 204 may prevent the power storage device 206 from receiving electrical power from the power source 202, for example, when the power storage device 206 is fully charged or when the power storage device 206 is being charged by one or more of smart glass of the plurality of smart glass 208. The controller 204 may also permit the power storage device 206 to receive electrical power from the power source 202 when the power storage device 206 is not fully charged, when the power storage device 206 is providing electrical power to one or more smart glass of the plurality of smart glass 208, and/or when one or more smart glass of the plurality of smart glass 208 are providing electrical power to the power storage device 206 for power storage.

The controller 204 may control power transmission from the power storage device 206 and/or the power source 202 and the controller 204 may control power transmission to at least one smart glass of the plurality of smart glass 208. For example, the controller 204 may control the power storage device 206 and/or the power source 202, via the power storage device 206 to provide electrical power to one or more smart glass of the plurality of smart glass 208 to increase, decrease, maintain, or clear a tint of the one or more smart glass. The controller 204 may control power transmission from at least one smart glass of the plurality of smart glass 208 and/or the power source 202 and to the power storage device 206. For example, the controller 204 may control power transmission from one or more smart glass of the plurality of smart glass 208 during tint clearing and to the power storage device 206 for power storage. Additionally, or alternatively, the controller 204 may control power transmission from the power source 202 to the power storage device 206 while the power storage device 206 receives power from the one or more smart glass of the plurality of smart glass 208. In some aspects, the controller 204 may control power transmission between each of the plurality of smart glass 208. For instance, the controller 204 may direct a transmission of power from the first smart glass 208a and to at least one of the second smart glass 208b, the third smart glass 208c, or the fourth smart glass 208d. As another instance, the controller 204 may direct a transmission of power from at least one of the first smart glass 208a, the second smart glass 208b, or the third smart glass 208c and to the fourth smart glass 208d.

FIG. 6 illustrates a block diagram of an example system 600 according to some aspects of this disclosure. The system 600 may include one or more same or similar features as the features described with respect to or illustrated in FIGS. 1, 2, 3, 4, 5, 7, 8, 9, 10, 11, 12, 13, 14, 15, and 16. For example, the system 600 may include one or more same or similar features as the EC system 100 illustrated in FIG. 1, the system 200 illustrated in FIGS. 2, 3, and 4, the system 500 illustrated in FIG. 5, the system 700 illustrated in FIG. 7, the system 800 illustrated in FIG. 8, the system 1000 illustrated in FIG. 10, the system 1200 illustrated in FIG. 12, and the system 1400 illustrated in FIG. 14. FIG. 6, as with the other included figures, is shown for illustrative purposes and does not limit either the possible embodiments of the present invention or the claims.

As shown in FIG. 6, the system 600 includes a first power source 202a, a first power connection 602a, a first controller 204a, a first power storage device 206a, and a first set of one or more smart glass(es) 208a. The system 600 may also include a second power source 202b, a second power connection 602b, a second controller 204b, a second power storage device 206b, and a second set of one or more smart glass(es) 208b. In addition, the system 600 may include an Nth power source 202n, an Nth power connection 602b, an Nth controller 204n, an Nth power storage device 206n, and an Nth set of one or more smart glass(es) 208n. The term “Nth” may be used to indicate than any number or quantity of groups including a power source, a power connection, a controller, a power storage device, and a set of one or more smart glasses may be included with the system 600. Each of the power connections including the first power connection 602a, the second power connection 602b, and the Nth power connection 602n may be in electrical or electronic communication with the central controller 601. The central controller 601 may control a plurality of power connections to distribute power between the respective power storage devices and the respective power sources, and the respective sets of one or more smart glass as described herein. In some aspects, the central controller 601 may be specific to a smart glass system (e.g., the smart glass system 600). Additionally, or alternatively, the central controller 601 may be part of a building automation system (BAS), coupled to a user interface, may be a remote electronic device, and/or may be a remote electronic handheld device.

In some aspects, the central controller 601 may direct the first power connection 602a to control power transmission from the first power source 202a and/or the first power storage device 206a and may direct the first power connection 602a to distribute and/or transmit power through the first controller 204a and between the first power source 202a, the first power storage device 206a, and/or each of the first set of smart glass 208a. For example, the central controller 601 may direct the first power connection 602a to control the transmission of electrical power from the first power source 202a and to the first power storage device 206a. In some aspects, the central controller 601 may direct the first power connection 602a to control the first power storage device 206a to receive electrical power from the first power source 202a. For instance, via the first power connection 602a, the central controller 601 may prevent the first power storage device 206a from receiving electrical power from the first power source 202a, for example, when the first power storage device 206a is fully charged or when the first power storage device 206a is being charged by at least one smart glass unit of the first set of smart glass 208a. The central controller 601 may also permit, via the first power connection 602a, the first power storage device 206a to receive electrical power from the first power source 202a when the first power storage device 206a is not fully charged, when the first power storage device 206a is providing electrical power to at least one smart glass unit of the first set of smart glass 208a, and/or when at least one smart glass unit of the first set of smart glass 208a are providing electrical power to the first power storage device 206a for power storage. Similarly, the central controller 601 may direct the second power connection 602b to control power transmission from the second power source 202b and/or the second power storage device 206b and may direct the second power connection 602b to distribute and/or transmit power through the second controller 204b and between the second power source 202b, the second power storage device 206b, and/or each of the second set of smart glass 208b. Also, similarly, the central controller 601 may direct the Nth power connection 602n to control power transmission from the Nth power source 202n and/or the Nth power storage device 206n and may direct the Nth power connection 602n to distribute and/or transmit power through the Nth controller 204n and between the Nth power source 202n, the Nth power storage device 206n, and/or each of the Nth set of smart glass 208n.

In some aspects, the central controller 601 may control the first power connection 602a to transmit power from the first power storage device 206a and/or the first power source 202a and to at least one smart glass of the first set of smart glass 208a. For example, the central controller 601 may control the first power connection 602a to distribute or provide power from the power storage device 206 and/or the power source 202, and distribute or provide power to at least one smart glass unit of the first set of smart glass 208a to increase, decrease, maintain, or clear a tint of the at least one smart glass unit. The central controller 601 may control the first power connection 602a to distribute or provide power from at least one smart glass unit of the first set of smart glass 208a and/or the first power source 202a and may control the first power connection 602a to direct power to the first power storage device 206a. For example, the central controller 601 may control the first power connection 602a to direct or distribute power from at least one smart glass of the first set of smart glass 208a during tint clearing and to the first power storage device 206a for power storage. Additionally, or alternatively, the central controller 601 may control the first power connection 602a to direct or distribute power from the first power source 202a to the first power storage device 206a while the first power storage device 206a receives power from the at least one smart glass unit of the first set of smart glass 208a. In some aspects, the central controller 601 may control power transmission between each of the first set of smart glass 208a. For instance, the central controller 601 may direct, via the first controller 204a, a transmission of power from a first smart glass unit of the first set of smart glass 208a and to at least one other smart glass unit of the first set of smart glass 208a.

In some aspects, for example, when two or more power sources (e.g., the first power source 202a, the second power source 202b, and/or through the Nth power source 202n), are a same power source or draw power from a same central power source, the central controller 601 may direct each of the power connections (e.g., the first power connection 602a, the second power connection 602b, and/or the Nth power connection 602n) to distribute and/or provide power among the glass units of the sets of smart glass (e.g., the first set of smart glass 208a, the second set of smart glass 208b, and/or the Nth set of smart glass 208n). For example, the central controller 601 may determine that the first power storage device 206a is fully charged and that all of the smart glass units from the second set of smart glass 208a and the Nth set of smart glass 208n are drawing power from the second power source 202b and the Nth power source 202n, respectively, to maintain a tint. The central controller 601 may also determine that at least one smart glass unit from the first set of smart glass 208a needs to change a tint (e.g., increase a level of tint). In response, the central controller 601 may direct the first power connection 602a to distribute power from the first power storage device 206a to the at least one smart glass unit of the first set of smart glass 208a to change a tint level. As another example, the central controller 601 may determine that the first power storage device 206a is fully charged and that all of the smart glass units from the second set of smart glass 208a and the Nth set of smart glass 208n are drawing power from the second power source 202b and the Nth power source 202n, respectively, to maintain a tint. The central controller 601 may also determine that at least one smart glass unit from the first set of smart glass 208a also needs to maintain a tint. In response, the central controller 601 may direct the first power connection 602a to distribute power from the first power storage device 206a (e.g., rather than the first power source 202a) to the at least one smart glass unit of the first set of smart glass 208a to change a tint level. The system 600 including the central controller 601 and two or more power sources to manage (e.g., reduce) power consumption.

FIG. 7 illustrates a block diagram of an example system 700 according to some aspects of this disclosure. The system 700 may include one or more same or similar features as the features described with respect to or illustrated in FIGS. 1, 2, 3, 4, 5, 6, 8, 9, 10, 11, 12, 13, 14, 15, and 16. For example, the system 700 may include one or more same or similar features as the EC system 100 illustrated in FIG. 1, the system 200 illustrated in FIGS. 2, 3, and 4, the system 500 illustrated in FIG. 5, the system 600 illustrated in FIG. 6, the system 800 illustrated in FIG. 8, the system 1000 illustrated in FIG. 10, the system 1200 illustrated in FIG. 12, and the system 1400 illustrated in FIG. 14. FIG. 7, as with the other included figures, is shown for illustrative purposes and does not limit either the possible embodiments of the present invention or the claims.

As shown in FIG. 7, the system 700 includes the power source 202, the controller 204, the plurality of smart glass 208 including the including the first smart glass 208a, the second smart glass 208b, the third smart glass 208c, and the fourth smart glass 208d, and at least two power storage devices including a first power storage device 706a and a second power storage device 706b. The first power storage device 706a and the second power storage device 706b may include one or more same or similar features as the power storage device 206 described herein. The first power storage device 706a may be electrically connected to the controller 204 and may be electrically connected to the power source 202, the second power storage device 706b, and the plurality of smart glass 208 via the controller 204. The first power storage device 706a may have a parallel configuration with respect to the second power storage device 706b, the power source 202, and the plurality of smart glass 208. The second power storage device 706b may be electrically connected to the power source 202 and the controller 204 directly in a series configuration. The second power storage device 706b may electrically connected to the plurality of smart glass 208 via the controller 204. The first smart glass 208a, the second smart glass 208b, and the third smart glass 208c may be electrically connected to the controller 204 in a parallel configuration. The controller 204 may direct or controller the transmission of power from the power source 202, the first power storage device 706a, the second power storage device 706b, and/or at least one smart glass of the plurality of smart glass 208 and to at least one of the first smart glass 208a, the second smart glass 208b, or the third smart glass 208c in order to controller a tint of at least one of the first smart glass 208a, the second smart glass 208b, or the third smart glass 208c. The fourth smart glass 208d may be electrically connected directly to the third smart glass 208c. The controller 204 may direct or controller the transmission of power between the third smart glass 208c and the fourth smart glass 208d in order to controller a tint of the third smart glass 208c and the fourth smart glass 208d.

The controller 204 may control power transmission from the power source 202, the first power storage device 706a, and/or the second power storage device 706b and may control the distribution and/or transmission of power between the power source 202, the first power storage device 706a, the second power storage device 706b, and/or each of the plurality of smart glass 208. For example, the controller 204 may direct or controller the transmission of electrical power from the power source 202 and to the first power storage device 706a and/or the second power storage device 706b. In some aspects, the controller 204 may direct or control the power storage device 206 to receive electrical power from the power source 202 via the power connection 602. For instance, the controller 204 may prevent at least one of the first power storage device 706a or the second power storage device 706b from receiving electrical power from the power source 202, for example, when at least one of the first power storage device 706a or the second power storage device 706b is fully charged or when at least one of the first power storage device 706a or the second power storage device 706b is being charged by one or more of smart glass of the plurality of smart glass 208. The controller 204 may also permit the first power storage device 706a or the second power storage device 706b to receive electrical power from the power source 202, when the at least one of the first power storage device 706a or the second power storage device 706b is not fully charged, when the at least one of the first power storage device 706a or the second power storage device 706b is providing electrical power to one or more smart glass of the plurality of smart glass 208, and/or when one or more smart glass of the plurality of smart glass 208 are providing electrical power to at least one of the first power storage device 706a or the second power storage device 706b for power storage.

The controller 204 may direct or control power transmission from the first power storage device 706a, the second power storage device 706b, and/or the power source 202 and to at least one smart glass of the plurality of smart glass 208. For example, the controller 204 may control at least one of the first power storage device 706a, the second power storage device 706b, and/or the power source 202 to provide electrical power to one or more smart glass of the plurality of smart glass 208 to increase, decrease, maintain, or clear a tint of the one or more smart glass. The controller 204 may control power transmission from at least one smart glass of the plurality of smart glass 208 and/or the power source 202 and to at least one of the first power storage device 706a or the second power storage device 706b. For example, the controller 204 may control power transmission from one or more smart glass of the plurality of smart glass 208 during tint clearing and to at least one of the first power storage device 706a or the second power storage device 706b for power storage. Additionally, or alternatively, the controller 204 may control power transmission from the power source 202 to at least one of the first power storage device 706a or the second power storage device 706b, while the first power storage device 706a and/or the second power storage device 706b receives power from the one or more smart glass of the plurality of smart glass 208. In some aspects, the controller 204 may direct or control power transmission between each of the plurality of smart glass 208. For instance, the controller 204 may direct a transmission of power from the first smart glass 208a and to at least one of the second smart glass 208b, the third smart glass 208c, or the fourth smart glass 208d. As another instance, the controller 204 may direct a transmission of power from at least one of the first smart glass 208a, the second smart glass 208b, or the third smart glass 208c and to the fourth smart glass 208d.

FIG. 8 illustrates a wiring diagram of an example system 800 according to some aspects of this disclosure. The system 800 may include one or more same or similar features as the features described with respect to or illustrated in FIGS. 1, 2, 3, 4, 5, 6, 7, 9, 10, 11, 12, 13, 14, 15, and 16. For example, the system 800 may include one or more same or similar features as the EC system 100 illustrated in FIG. 1, the system 200 illustrated in FIGS. 2, 3, and 4, the system 500 illustrated in FIG. 5, the system 600 illustrated in FIG. 6, the system 700 illustrated in FIG. 7, the system 1000 illustrated in FIG. 10, the system 1200 illustrated in FIG. 12, and the system 1400 illustrated in FIG. 14. FIG. 8, as with the other included figures, is shown for illustrative purposes and does not limit either the possible embodiments of the present invention or the claims.

As shown in FIG. 8, the system 800 includes the controller 204, the power storage device 206, a first synchronous converter 802a, a second synchronous converter 802b, a third synchronous converter 802c, a supply rail 805, and a smart glass 208. The synchronous converters 802a, 802b, and 802c (e.g., synchronous converters) may be configured to increase a voltage of an incoming current and/or decrease a voltage of an incoming current. In some aspects, the synchronous converters 802a, 802b, and 802c may be a buck converter to decrease a voltage of an incoming current, a boost converter to increase a voltage of an incoming current, or a buck-boost converter to decrease or increase a voltage of an incoming current. Each of the synchronous converters 802a, 802b, and 802c may include a controller and one or more switches controlled by the controller. For example, the first synchronous converter 802a may include a first synchronous converter controller (e.g., a power storage device controller, a controller) 803a and one or more switches 804a. The second synchronous converter 802b may include a second synchronous converter controller 803b and one or more switches 804b. The third synchronous converter 802c may include a third synchronous converter controller 803c and one or more switches 804c. The controller 204 may be in electrical (e.g., data, one or more signals) communication with each of the controllers 803a, 803b, and 803c of the respective synchronous converters 802a, 802b, and 802c via the controller communication line 807 to control the switches 804a, 804b, and 804c of the respective synchronous converters 802a, 802b, and 802c and the direction of electrical power communication through the respective synchronous converters 802a, 802b, and 802c for increasing or decreasing a voltage, for changing or maintaining a level of tint of the smart glass 208, and/or for drawing power from the smart glass 208 for storage in the power storage device 206 and subsequent reuse. The power storage device 206 may be in electrical communication with the first synchronous converter 802a via the first electrical line 808. The first synchronous converter 802a may be in electrical communication with the second synchronous converter 802b and the third synchronous converter 802c via the supply rail 805. The second synchronous converter 802b may be in electrical communication with the smart glass 208 via the second electrical line 810. The third synchronous converter 802c may be in electrical communication with the smart glass 208 via the third electrical line 812. In some aspects, the third electrical line 812 may be a ground electrical line. In some aspects, the second synchronous converter 802b and the third synchronous converter 802c may provide a same or similar step or change in voltage (e.g., an increase in voltage, a decrease in voltage).

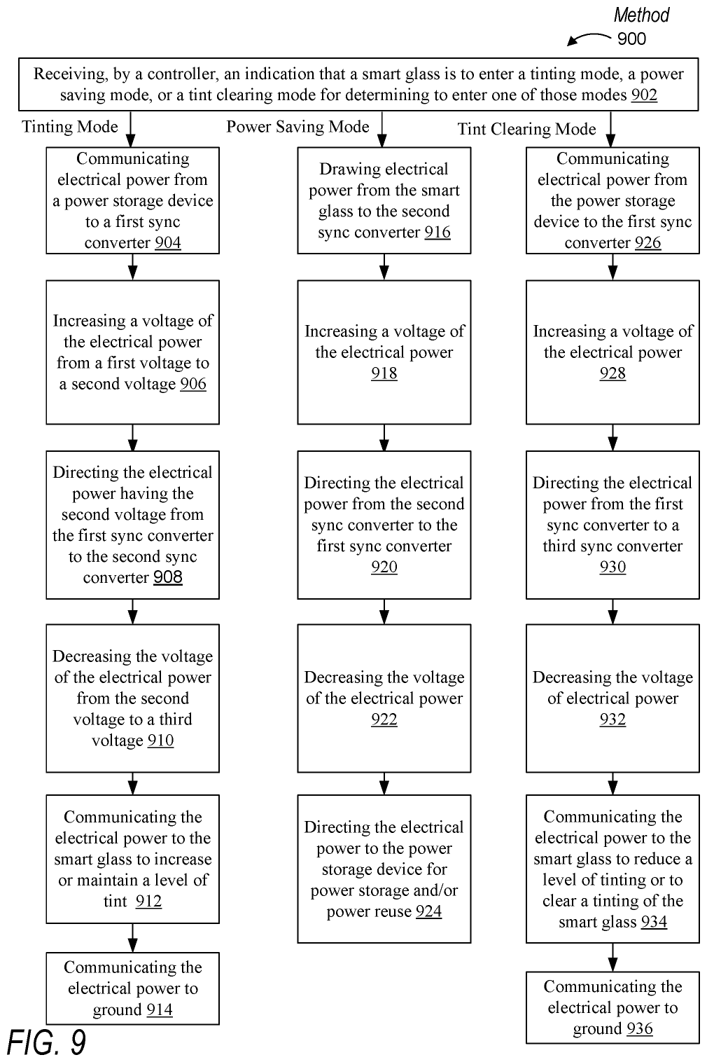

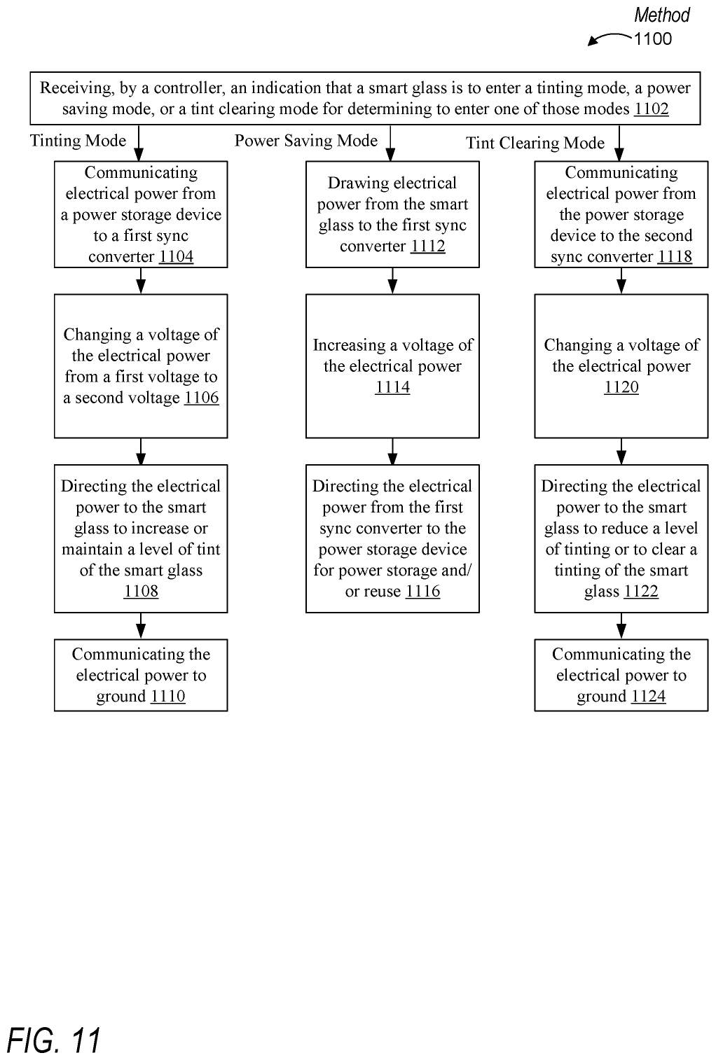

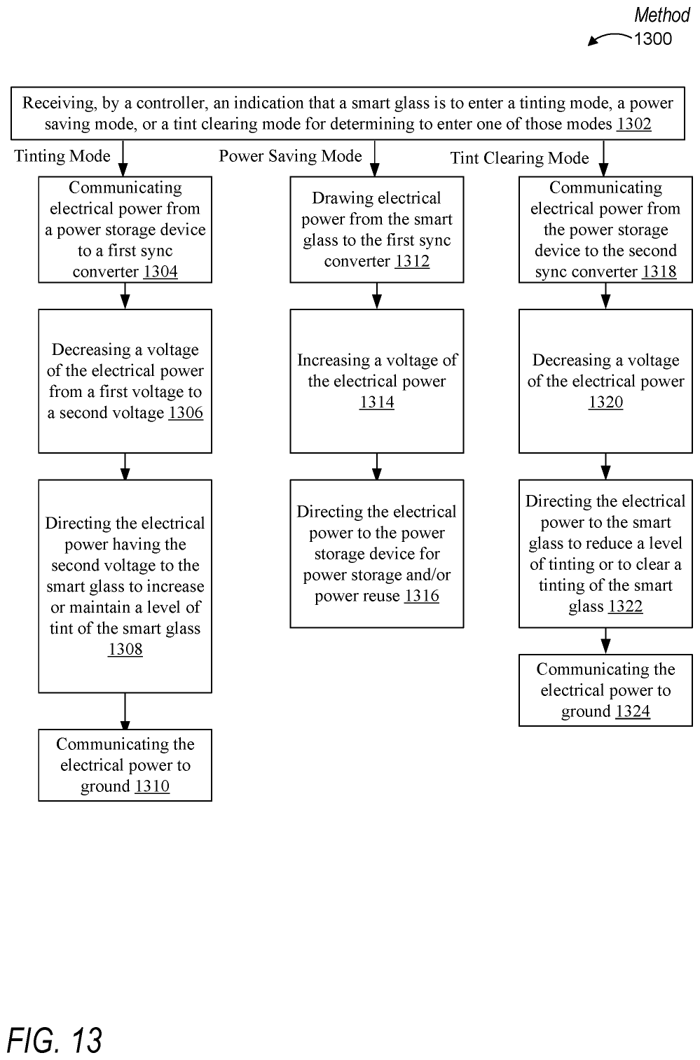

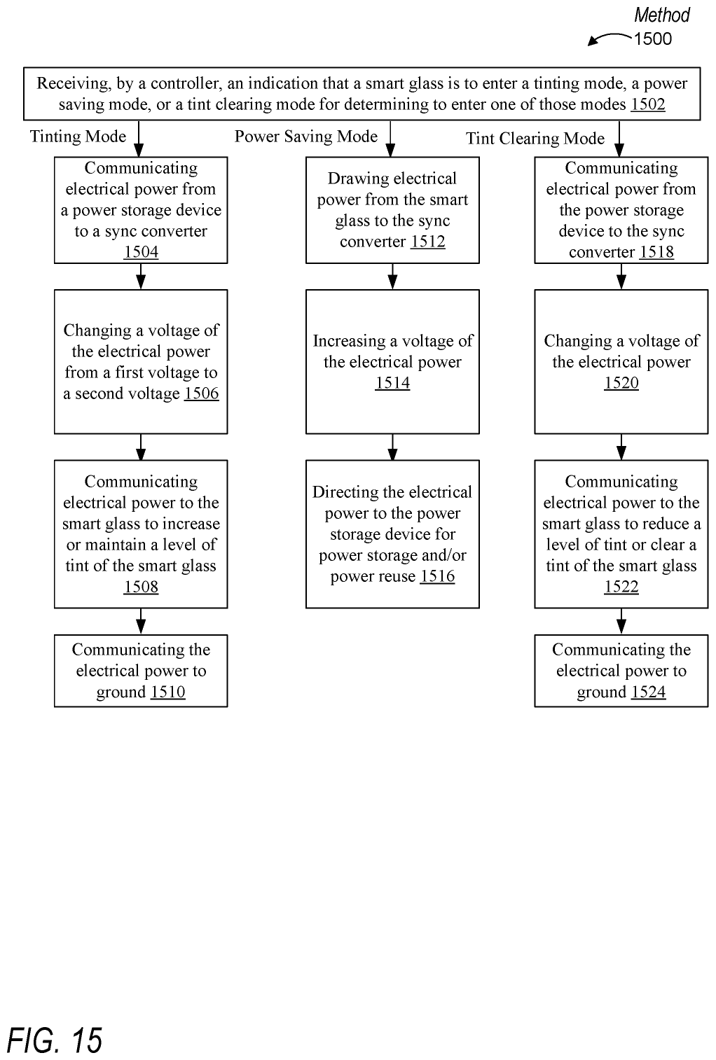

FIG. 9 illustrates an example method 900 for smart glass power reuse according to some aspects of this disclosure. In some aspects, the method 900 may be implemented using the system 800 illustrated in FIG. 8. One or more steps or one or more aspects of the method 900 may be implemented using the systems described or illustrated in FIGS. 1, 2, 3, 4, 5, 6, 7, 8, 10, 12, 14, and 16. For example, one or more steps or one or more aspects of the method 900 may be implemented with the EC system 100 illustrated in FIG. 1, the system 200 illustrated in FIGS. 2, 3, and 4, the system 500 illustrated in FIG. 5, the system 600 illustrated in FIG. 6, the system 700 illustrated in FIG. 7, the system 1000 illustrated in FIG. 10, the system 1200 illustrated in FIG. 12, and the system 1400 illustrated in FIG. 14. One or more steps or one or more aspects of the method 900 may be included with and/or include one or more steps or one or more aspects of the method 1100 illustrated in FIG. 11, the method 1300 illustrated in FIG. 13, and/or the method 1500 illustrated in FIG. 15. FIG. 9, as with the other included figures, is shown for illustrative purposes and does not limit either the possible embodiments of the present invention or the claims.

At step 902, the controller 204 may receive an indication (e.g., from a user interface, based on one or more predetermined parameters, based on one or more sensed parameters, or the like) that the smart glass 208 is to enter a tinting mode to increase a level of tint (e.g., darken, become less transparent) or maintain a level of tinting, enter a power saving mode, or enter a tint clearing mode to decrease a level of tint (e.g., lighten, become more transparent) or clear a tint. When the controller 204 receives (e.g., in response to the controller 204 receiving) an indication that the smart glass 208 is to enter a tinting mode, at step 904, the controller 204 may direct or provide electrical power from the power storage device 206 to the first synchronous converter 802a via the first electrical line 808. The electrical power from the power storage device 206 may have a first voltage. At step 906, the controller 204 may direct the first synchronous converter 802a to increase a voltage of the electrical power from the first voltage to a second voltage. For example, the controller 204 may direct the power storage device 206 to provide a first voltage of about 3.0 volts to the first synchronous converter 802a. The controller 204 may direct the first synchronous converter 802a to increase or step-up the first voltage to a second voltage of about 6.0 volts. At step 908, the controller 204 may direct the electrical power having the second voltage from the first synchronous converter 802a to the second synchronous converter 802b via the supply rail 805. At step 910, the controller 204 may direct the second synchronous converter 802b to decrease or step-down the voltage of the electrical power received via the supply rail 805 from the second voltage to a third voltage. For example, the controller 204 may direct the second synchronous converter 802b to decrease or step-down the electrical power having the second voltage of about 6 volts to a third voltage of about 4 volts. At step 912, the controller 204 may direct or communicate the electrical power having the third voltage, through the second electrical line 810, to the smart glass 208 to increase a level of tint of the smart glass 208 or maintain a level of tint of the smart glass 208 using the third voltage. At step 914, the controller 204 may direct the electrical power (e.g., having zero volts or nearly zero volts) to ground or the electrical power may return to ground. For example, the controller 204 may direct the electrical power from the smart glass 208, through the third electrical line 812, to the ground line 814c. As another example, the electrical power may return to ground through the third electrical line 812 and the ground line 814c.

When the controller 204 receives (e.g., in response to the controller 204 receiving) an indication that the smart glass 208 is to enter a power saving mode, at step 916, the controller 204 may cause electrical power having a fourth voltage to be drawn from the smart glass 208 (the smart glass having a level of tint that is above a zero level of tint, the smart glass holding a non-zero voltage), through the second electrical line 810, and to the second synchronous converter 802b. For example, the controller 204 may cause electrical power having a fourth voltage of about 1.0 volts to be drawn from the smart glass 208, through the second electrical line 810, and to the second synchronous converter 802b. In some aspects, the controller 204 may cause electrical power having a fourth voltage to be drawn from the smart glass 208, through the second electrical line 810, and to the second synchronous converter 802b after the controller 204 directs or communicates the electrical power having the third voltage, through the second electrical line 810, to the smart glass 208 to increase a level of tint of the smart glass 208 or maintain a level of tint of the smart glass 208 using the third voltage as described with respect to step 912 and/or after the controller 204 directs the electrical power (e.g., having zero volts or nearly zero volts) from the smart glass 208, through the third electrical line 812, to ground as described with respect to step 914. At step 918, the controller 204 may direct the second synchronous converter 802b to increase or step-up a voltage of the electrical power from the second electrical line 810 from the fourth voltage to a fifth voltage. For example, the controller 204 may direct the second synchronous converter 802b to increase a voltage of the electrical power from the second electrical line 810 from the fourth voltage of about 1.0 volts to a fifth voltage of about 6.0 volts. At step 920, the controller 204 may direct the electrical power having the fifth voltage from the second synchronous converter 802b to the first synchronous converter 802a through the supply rail 805. At step 922, the controller 204 may direct the first synchronous converter 802a to decrease or step-down the voltage of the electrical power from the fifth voltage to a sixth voltage. For example, the controller 204 may direct the first synchronous converter 802a to decrease or step-down the voltage of the electrical power from the fifth voltage of about 6.0 volts to a sixth voltage of about 3.0 volts. At step 924, the controller 204 may direct the electrical power having the sixth voltage, through the first electrical line 808, to the power storage device 206 for power storage and/or power reuse.

When the controller 204 receives (e.g., in response to the controller 204 receiving) an indication that the smart glass 208 is to enter a tint clearing mode, at step 926, the controller 204 may direct or communicate electrical power from the power storage device 206 to the first synchronous converter 802a. In some aspects, the controller 204 may direct or communicate electrical power from the power storage device 206 to the first synchronous converter 802a after the controller directs the electrical power having the sixth voltage, through the first electrical line 808, to the power storage device 206 for power storage and/or power reuse as described with respect to step 924. The electrical power from the power storage device 206 may have a seventh voltage. At step 928, the controller 204 may direct or control the first synchronous converter 802a to increase or step-up a voltage of the electrical power from the seventh voltage to an eighth voltage. For example, the controller 204 may direct the power storage device 206 to provide a seventh voltage of about 3.0 volts to the first synchronous converter 802a. The controller 204 may direct the first synchronous converter 802a to increase or step-up the seventh voltage to an eighth voltage of about 6.0 volts. At step 930, the controller 204 may direct or communicate the electrical power having the eighth voltage from the first synchronous converter 802a to a third synchronous converter 802c through the supply rail 805. At step 932, the controller 204 may direct or control the third synchronous converter 802s to decrease or step-down the voltage of electrical power from the eighth voltage to a ninth voltage. For example, the controller 204 may direct the third synchronous converter 802c to decrease or step-down the electrical power having the eighth voltage of about 6 volts to a ninth voltage of about 4 volts. At step 934, the controller 204 may direct the electrical power having the ninth voltage through the third electrical line 812, to the smart glass 208 to reduce a level of tinting or to clear a tinting of the smart glass 208 using the ninth voltage. At step 936, the controller 204 may direct the electrical power to ground or the electrical power may return to ground. For example, the controller 204 may direct the electrical power from the smart glass 208, through the second electrical line 810, to the ground line 814b. As another example, the electrical power may return to ground through the second electrical line 810 and the ground line 814b.

Please note that the functional block(s) described herein are illustrated in FIG. 9 in merely one example arrangement. In other embodiments, the techniques and functionality described above may be performed using different steps in different orders or may be grouped into a different number of steps or may be performed as a single method without distinct steps.

FIG. 10 illustrates a wiring diagram of an example 1000 system according to some aspects of this disclosure. The system 1100 may include one or more same or similar features as the features described with respect to or illustrated in FIGS. 1, 2, 3, 4, 5, 6, 7, 8 9, 11, 12, 13, 14, 15, and 16. For example, the system 1000 may include one or more same or similar features as the EC system 100 illustrated in FIG. 1, the system 200 illustrated in FIGS. 2, 3, and 4, the system 500 illustrated in FIG. 5, the system 600 illustrated in FIG. 6, the system 700 illustrated in FIG. 7, the system 800 illustrated in FIG. 8, the system 1200 illustrated in FIG. 12, and the system 1400 illustrated in FIG. 14. FIG. 10, as with the other included figures, is shown for illustrative purposes and does not limit either the possible embodiments of the present invention or the claims.

As shown in FIG. 10, the system 1000 includes the controller 204, the power storage device 206, a first synchronous converter 1002a, a second synchronous converter 1002b, a supply rail 1005, and a smart glass 208. The synchronous converters 1002a and 1002b (e.g., synchronous converters) may be configured to increase a voltage of an incoming current and/or decrease a voltage of an incoming current. In some aspects, the synchronous converters 1002a and 1002b may be a buck converter to decrease a voltage of an incoming current, a boost converter to increase a voltage of an incoming current, or a buck-boost converter to decrease or increase a voltage of an incoming current. Each of the synchronous converters 1002a and 1002b may include a controller and one or more switches controlled by the controller. For example, the first synchronous converter 1002a may include a first synchronous converter controller 1003a and one or more switches 1004a. The second synchronous converter 1002b may include a second synchronous converter controller 1003b and one or more switches 1004b. The controller 204 may be in electrical (e.g., data) communication with each of the controllers 1003a and 1003b of the respective synchronous converters 1002a and 1002b via the controller communication line 1007 to control the switches 1004a and 1004b of the respective synchronous converters 1002a and 1002b and the direction of electrical power communication through the respective synchronous converters 1002a and 1002b for increasing or decreasing a voltage, for changing or maintain a level of tint of the smart glass 208, and/or for drawing power from the smart glass 208 for storage in the power storage device 206 and subsequent reuse. The power storage device 206 may be in electrical communication with the first synchronous converter 1002a via the first electrical line 1008. For example, the first electrical line 1008 may enable power or electricity to be provided from the power storage device 206 to the first synchronous converter 1002a. As another example, the first electrical line 1008 may enable power or electricity to be provided from the first synchronous converter 1002a and to the power storage device 206. The first synchronous converter 1002a may be in electrical communication with the smart glass 208 via the second electrical line 1010. The smart glass 208 may be in electrical communication with the second synchronous converter 1002b via the third electrical line 1012. The second synchronous converter 1002b may be in electrical communication with the power storage device 206 and the first synchronous converter 1002a via the supply rail 1005. In some aspects, the third electrical line 1012 may be a ground electrical line or a nearly ground electrical line. In some aspects, the first synchronous converter 1002a and the second synchronous converter 1002b may provide a same or similar step or change in voltage (e.g., an increase in voltage, a decrease in voltage).

FIG. 11 illustrates an example method 1100 for smart glass power reuse according to some aspects of this disclosure. In some aspects, the method 1100 may be implemented using the system 1000 illustrated in FIG. 10. One or more steps or one or more aspects of the method 1100 may be implemented using the systems described or illustrated in FIGS. 1, 2, 3, 4, 5, 6, 7, 8, 10, 12, 14, and 16. For example, one or more steps or one or more aspects of the method 1100 may be implemented with the EC system 100 illustrated in FIG. 1, the system 200 illustrated in FIGS. 2, 3, and 4, the system 500 illustrated in FIG. 5, the system 600 illustrated in FIG. 6, the system 700 illustrated in FIG. 7, the system 800 illustrated in FIG. 8, the system 1200 illustrated in FIG. 12, and the system 1400 illustrated in FIG. 14. One or more steps or one or more aspects of the method 1100 may be included with and/or include one or more steps or one or more aspects of the method 900 illustrated in FIG. 9, the method 1300 illustrated in FIG. 13, and/or the method 1500 illustrated in FIG. 15. FIG. 11, as with the other included figures, is shown for illustrative purposes and does not limit either the possible embodiments of the present invention or the claims.

At step 1102, the controller 204 may receive an indication (e.g., from a user interface, based on one or more predetermined parameters, based on one or more sensed parameters, or the like) that the smart glass 208 is to enter a tinting mode to increase a level of tint (e.g., darken, become less transparent) or maintain a level of tinting, enter a power saving mode, or enter a tint clearing mode to decrease a level of tint (e.g., lighten, become more transparent) or clear a tint. When the controller 204 receives (e.g., in response to the controller 204 receiving) an indication that the smart glass 208 is to enter a tinting mode, at step 1104, the controller 204 may direct or communicate electrical power from the power storage device 206 to the first synchronous converter 1002a via the first electrical line 1008. The electrical power from the power storage device 206 may have a first voltage. At step 1106, the controller 204 may direct the first synchronous converter 1002a to change a voltage of the electrical power from the first voltage to a second voltage. For example, the controller 204 may direct the power storage device 206 to provide a first voltage of about 3.0 volts to the first synchronous converter 1002a. The controller 204 may direct the first synchronous converter 1002a to increase or step-up the first voltage to a second voltage of about 4.0 volts. As another example, the controller 204 may direct the power storage device 206 to provide a first voltage of about 6.0 volts to the first synchronous converter 1002a. The controller 204 may direct the first synchronous converter 1002a to decrease or step-down the first voltage to the second voltage of about 4.0 volts. At step 1108, the controller 204 may direct the electrical power having the second voltage from the first synchronous converter 802a to the smart glass 208 via the second electrical line 1010 to increase a level of tint of the smart glass 208 or maintain a level of tint of the smart glass 208 using the second voltage. At step 1110, the controller 204 may direct the electrical power (e.g., having zero volts or nearly zero volts) to ground or the electrical power may return to ground. For example, the controller 204 may direct the electrical power from the smart glass 208, through the third electrical line 1012, to the ground line 1014b. As another example, the electrical power may return to ground through the third electrical line 1012 and the ground line 1014b.

When the controller 204 receives (e.g., in response to the controller 204 receiving) an indication that the smart glass 208 is to enter a power saving mode, at step 1112, the controller 204 may cause electrical power having a third voltage to be drawn from the smart glass 208 (the smart glass having a level of tint that is above a zero level of tint, the smart glass holding a non-zero voltage), through the second electrical line 1010, and to the first synchronous converter 1002b. For example, the controller 204 may cause electrical power having a third voltage of about 1.0 volts to be drawn from the smart glass 208, through the second electrical line 1010, and to the first synchronous converter 1002a. In some aspects, the controller 204 may cause electrical power having a third voltage to be drawn from the smart glass 208, through the second electrical line 1010, and to the first synchronous converter 1002b after the controller 204 directs the electrical power having the second voltage from the first synchronous converter 802a to the smart glass 208 via the second electrical line 1010 to increase a level of tint of the smart glass 208 or maintain a level of tint of the smart glass 208 using the second voltage as described with respect to step 1108 and/or after the controller 204 directs the electrical power (e.g., having zero volts or nearly zero volts) from the smart glass 208, through the third electrical line 1012, to ground as described with respect to step 1110. At step 1114, the controller 204 may direct the first synchronous converter 1002b to increase or step-up a voltage of the electrical power from the second electrical line 810 from the third voltage to a fourth voltage. For example, the controller 204 may direct the first synchronous converter 1002a to increase a voltage of the electrical power from the second electrical line 1010 from the third voltage of about 1.0 volts to a fourth voltage of about 6.0 volts or of about 3.0 volts depending on how much voltage is supplied from the power storage device 206 (e.g., as described in step 1106). At step 1116, the controller 204 may direct the electrical power having the fourth voltage from the first synchronous converter 1002a, through the first electrical line 1008, to the power storage device 206 for power storage and/or power reuse.

When the controller 204 receives (e.g., in response to the controller 204 receiving) an indication that the smart glass 208 is to enter a tint clearing mode, at step 1118, the controller 204 may direct electrical power from the power storage device 206 through the supply rail 1005 to the second synchronous converter 1002b. The electrical power from the power storage device 206 may have a fifth voltage. In some aspects, the controller 204 may direct electrical power from the power storage device 206 through the supply rail 1005 to the second synchronous converter 1002b after the controller 204 directs the electrical power having the fourth voltage from the first synchronous converter 1002a, through the first electrical line 1008, to the power storage device 206 for power storage and/or power reuse as described with respect to step 1116. At step 1120, the controller 204 may direct or control the second synchronous converter 1002b to change a voltage of the electrical power from the fifth voltage to a sixth voltage. For example, the controller 204 may direct the power storage device 206 to provide a first voltage of about 3.0 volts to the second synchronous converter 1002b via the supply rail 1005. The controller 204 may direct the second synchronous converter 1002b to increase or step-up the first voltage to a seventh voltage of about 4.0 volts. As another example, the controller 204 may direct the power storage device 206 to provide a sixth voltage of about 6.0 volts to the second synchronous converter 1002b via the supply rail 1005. The controller 204 may direct the second synchronous converter 1002b to decrease or step-down the sixth voltage to the seventh voltage of about 4.0 volts. At step 1122, the controller 204 may direct the electrical power having the seventh voltage through the third electrical line 1012, to the smart glass 208 to reduce a level of tinting or to clear a tinting of the smart glass 208 using the seventh voltage. At step 1124, the controller 204 may direct the electrical power to ground or the electrical power may return to ground. For example, the controller 204 may direct the electrical power from the smart glass 208, through the second electrical line 1010, the first synchronous converter 1002a, the first electrical line 1008, and to the ground line 1014a. As another example, the electrical power may return to ground from the smart glass 208, through the second electrical line 1010, through the first synchronous converter 1002a, through the first electrical line 1008, and to the ground line 1014a.

Please note that the functional block(s) described herein are illustrated in FIG. 11 in merely one example arrangement. In other embodiments, the techniques and functionality described above may be performed using different steps in different orders or may be grouped into a different number of steps or may be performed as a single method without distinct steps.

FIG. 12 illustrates a wiring diagram of an example system 1200 according to some aspects of this disclosure. The system 1200 may include one or more same or similar features as the features described with respect to or illustrated in FIGS. 1, 2, 3, 4, 5, 6, 7, 8, 9, 10, 11, 13, 14, 15, and 16. For example, the system 1200 may include one or more same or similar features as the EC system 100 illustrated in FIG. 1, the system 200 illustrated in FIGS. 2, 3, and 4, the system 500 illustrated in FIG. 5, the system 600 illustrated in FIG. 6, the system 700 illustrated in FIG. 7, the system 800 illustrated in FIG. 8, the system 1000 illustrated in FIG. 10, and the system 1400 illustrated in FIG. 14. FIG. 12, as with the other included figures, is shown for illustrative purposes and does not limit either the possible embodiments of the present invention or the claims.

As shown in FIG. 12, the system 1200 includes the controller 204, the power storage device 206, a first synchronous converter 1202a, a second synchronous converter 1202b, a supply rail 1205, and a smart glass 208. The synchronous converters 1202a and 1202b (e.g., synchronous converters) may be configured to increase a voltage of an incoming current and/or decrease a voltage of an incoming current. In some aspects, the synchronous converters 1202a and 1202b may be a buck converter to decrease a voltage of an incoming current, a boost converter to increase a voltage of an incoming current, or a buck-boost converter to decrease or increase a voltage of an incoming current. Each of the synchronous converters 1202a and 1202b may include a controller and one or more switches controlled by the controller. For example, the first synchronous converter 1202a may include a first synchronous converter controller 1203a and one or more switches 1204a. The second synchronous converter 1202b may include a second synchronous converter controller 1203b and one or more switches 1204b. The controller 204 may be in electrical (e.g., data) communication with each of the controllers 1203a and 1203b of the respective synchronous converters 1202a and 1202b via the controller communication line 1207 to control the switches 1204a and 1204b of the respective synchronous converters 1202a and 1202b and the direction of electrical power communication through the respective synchronous converters 1202a and 1202b for increasing or decreasing a voltage, for changing or maintain a level of tint of the smart glass 208, and/or for drawing power from the smart glass 208 for storage in the power storage device 206 and subsequent reuse. The power storage device 206 may be in electrical communication with the first synchronous converter 1202a and the second syn converter 1202b via the supply rail 1205. The first synchronous converter 1202a may be in electrical communication with the smart glass 208 via the first electrical line 1208. The second synchronous converter 1202b may be in electrical communication with the smart glass 208 via the second electrical line 1210. In some aspects, the second electrical line 1210 may be a ground electrical line. In some aspects, the first synchronous converter 1202a and the second synchronous converter 1202b may provide a same or similar step or change in voltage (e.g., an increase in voltage, a decrease in voltage).

FIG. 13 illustrates an example method 1300 for smart glass power reuse according to some aspects of this disclosure. In some aspects, the method 1300 may be implemented using the system 1200 illustrated in FIG. 12. One or more steps or one or more aspects of the method 1300 may be implemented using the systems described or illustrated in FIGS. 1, 2, 3, 4, 5, 6, 7, 8, 10, 12, 14, and 16. For example, one or more steps or one or more aspects of the method 1300 may be implemented with the EC system 100 illustrated in FIG. 1, the system 200 illustrated in FIGS. 2, 3, and 4, the system 500 illustrated in FIG. 5, the system 600 illustrated in FIG. 6, the system 700 illustrated in FIG. 7, the system 800 illustrated in FIG. 8, the system 1000 illustrated in FIG. 10, and the system 1400 illustrated in FIG. 14. One or more steps or one or more aspects of the method 1300 may be included with and/or include one or more steps or one or more aspects of the method 900 illustrated in FIG. 9, the method 1100 illustrated in FIG. 11, and/or the method 1500 illustrated in FIG. 15. FIG. 13, as with the other included figures, is shown for illustrative purposes and does not limit either the possible embodiments of the present invention or the claims.

At step 1302, the controller 204 may receive an indication (e.g., from a user interface, based on one or more predetermined parameters, based on one or more sensed parameters, or the like) that the smart glass 208 is to enter a tinting mode to increase a level of tint (e.g., darken, become less transparent) or maintain a level of tinting, enter a power saving mode, or enter a tint clearing mode to decrease a level of tint (e.g., lighten, become more transparent) or clear a tint. When the controller 204 receives (e.g., in response to the controller 204 receiving) an indication that the smart glass 208 is to enter a tinting mode, at step 1304, the controller 204 may direct or communicate electrical power from the power storage device 206 to the first synchronous converter 1202a via the supply rail 1205. The electrical power from the power storage device 206 may have a first voltage. At step 1306, the controller 204 may direct the first synchronous converter 1202a to decrease a voltage of the electrical power from the first voltage to a second voltage. For example, the controller 204 may direct the power storage device 206 to provide the first synchronous converter 1202a with a first voltage of about 6.0 volts. The controller 204 may direct the first synchronous converter 1202a to decrease or step-down the first voltage to a second voltage of about 4.0 volts. At step 1308, the controller 204 may direct the electrical power having the second voltage from the first synchronous converter 802a to the smart glass 208 to increase a level of tint of the smart glass 208 or maintain a level of tint of the smart glass 208 using the second voltage. At step 1310, the controller 204 may direct the electrical power (e.g., having zero volts or nearly zero volts) to ground or the electrical power may return to ground. For example, the controller 204 may direct the electrical power from the smart glass 208, through the second electrical line 1210 and to the ground line 1214b. As another example, the electrical power may return to ground from the smart glass 208, through the second electrical line 1210, and to the ground line 1214b.

When the controller 204 receives (e.g., in response to the controller 204 receiving) an indication that the smart glass 208 is to enter a power saving mode, at step 1312, the controller 204 may cause electrical power having a third voltage to be drawn from the smart glass 208 (the smart glass having a level of tint that is above a zero level of tint, the smart glass holding a non-zero voltage), through the first electrical line 1208, and to the first synchronous converter 1202a. For example, the controller 204 may cause electrical power having a third voltage of about 1.0 volts to be drawn from the smart glass 208, through the first electrical line 1208, and to the first synchronous converter 1202a. In some aspects, the controller 204 may cause electrical power having a third voltage to be drawn from the smart glass 208, through the first electrical line 1208, and to the first synchronous converter 1202a after the controller 204 directs the electrical power having the second voltage from the first synchronous converter 802a to the smart glass 208 to increase a level of tint of the smart glass 208 or maintain a level of tint of the smart glass 208 using the second voltage as described with respect to step 1308 and/or after the controller 204 directs or communicates the electrical power (e.g., having zero volts or nearly zero volts) from the smart glass 208, through the second electrical line 1210, to ground as described with respect to step 1310. At step 1314, the controller 204 may direct the first synchronous converter 1202a to increase or step-up a voltage of the electrical power from the first electrical line 1208 from the third voltage to a fourth voltage. For example, the controller 204 may direct the first synchronous converter 1202a to increase a voltage of the electrical power from the first electrical line 1208 from the third voltage of about 1.0 volts to a fourth voltage of about 6.0 volts. At step 1316, the controller 204 may direct or communicate the electrical power having the fourth voltage from the first synchronous converter 1202a through the supply rail 1205 to the power storage device 206 for power storage and/or power reuse.

When the controller 204 receives (e.g., in response to the controller 204 receiving) an indication that the smart glass 208 is to enter a tint clearing mode, at step 1318, the controller 204 may direct or communicate electrical power from the power storage device 206 to the second synchronous converter 1202b via the supply rail 1205. The electrical power from the power storage device 206 may have a fifth voltage. In some aspects, the controller 204 may direct or communicate electrical power from the power storage device 206 to the second synchronous converter 1202b via the supply rail 1205 after the controller 204 directs or communicates the electrical power having the fourth voltage from the first synchronous converter 1202a through the supply rail 1205 to the power storage device 206 for power storage and/or power reuse as described with respect to step 1316. At step 1320, the controller 204 may direct or control the second synchronous converter 1202b to decrease or step-down a voltage of the electrical power from the fifth voltage to a sixth voltage. For example, the controller 204 may direct the second synchronous converter 1202b to decrease or step-down the electrical power having the fifth voltage of about 6.0 volts to a sixth voltage of about 4.0 volts. At step 1322, the controller 204 may direct or communicate the electrical power having the sixth voltage through the second electrical line 1210, to the smart glass 208 to reduce a level of tinting or to clear a tinting of the smart glass 208 using the sixth voltage. At step 1324, the controller 204 may direct the electrical power (e.g., having zero volts or nearly zero volts) to ground or the electrical power may return to ground. For example, the controller 204 may direct the electrical power from the smart glass 208, through the first electrical line 1208 and to the ground line 1214a. As another example, the electrical power may return to ground from the smart glass 208, through the first electrical line 1208, and to the ground line 1214a.

Please note that the functional block(s) described herein are illustrated in FIG. 13 in merely one example arrangement. In other embodiments, the techniques and functionality described above may be performed using different steps in different orders or may be grouped into a different number of steps or may be performed as a single method without distinct steps.

FIG. 14 illustrates a wiring diagram of an example system 1400 according to some aspects of this disclosure. The system 1400 may include one or more same or similar features as the features described with respect to or illustrated in FIGS. 1, 2, 3, 4, 5, 6, 7, 8, 9, 10, 11, 12, 13, 15, and 16. For example, the system 1400 may include one or more same or similar features as the EC system 100 illustrated in FIG. 1, the system 200 illustrated in FIGS. 2, 3, and 4, the system 500 illustrated in FIG. 5, the system 600 illustrated in FIG. 6, the system 700 illustrated in FIG. 7, the system 800 illustrated in FIG. 8, the system 1000 illustrated in FIG. 10, and the system 1200 illustrated in FIG. 12. FIG. 14, as with the other included figures, is shown for illustrative purposes and does not limit either the possible embodiments of the present invention or the claims.

As shown in FIG. 14, the system 1400 includes the controller 204, the power storage device 206, a synchronous converter 1402a, a supply rail 1405, a first set of switches 1408a, a second set of switches 1408b, and a smart glass 208. The synchronous converter 1402 (e.g., synchronous converter) may be configured to increase a voltage of an incoming current and/or decrease a voltage of an incoming current. In some aspects, the synchronous converter 1402 may be a buck converter to decrease a voltage of an incoming current, a boost converter to increase a voltage of an incoming current, or a buck-boost converter to decrease or increase a voltage of an incoming current. The synchronous converter 1402 may include a synchronous converter controller 1403 and one or more switches 1404 controlled by the controller. The controller 204 may be in electrical (e.g., data) communication with the synchronous converter controller 1403 of the synchronous converter 1402 via the controller communication line 1407 to control the switches 1404 and the direction of electrical power communication through the synchronous converter 1402 for increasing or decreasing a voltage. The controller 204 may be in electrical (e.g., data) communication with the first set of switches 1408a and the second set of switches 1408b via the controller communication line 1407 to control the first set of switches 1408a and the second set of switches 1408b and the direction of electrical power communication through the first electrical line 1410, the second electrical line 1412, and the third electrical line 1414 and thus through the smart glass 208 for changing or maintain a level of tint of the smart glass 208, and/or for drawing power from the smart glass 208 for storage in the power storage device 206 and subsequent reuse. The power storage device 206 may be in electrical communication with the synchronous converter 1402 via the supply rail 1405. The synchronous converter 1402 may be in electrical communication with the smart glass 208 via the first electrical line 1410, the second electrical line 1412, and/or the third electrical line 1414.

FIG. 15 illustrates an example method 1500 for smart glass power reuse according to some aspects of this disclosure. In some aspects, the method 1500 may be implemented using the system 1400 illustrated in FIG. 14. One or more steps or one or more aspects of the method 1500 may be implemented using the systems described or illustrated in FIGS. 1, 2, 3, 4, 5, 6, 7, 8, 10, 12, 14, and 16. For example, one or more steps or one or more aspects of the method 1500 may be implemented with the EC system 100 illustrated in FIG. 1, the system 200 illustrated in FIGS. 2, 3, and 4, the system 500 illustrated in FIG. 5, the system 600 illustrated in FIG. 6, the system 700 illustrated in FIG. 7, the system 800 illustrated in FIG. 8, the system 1000 illustrated in FIG. 10, and the system 1200 illustrated in FIG. 12. One or more steps or one or more aspects of the method 1500 may be included with and/or include one or more steps or one or more aspects of the method 900 illustrated in FIG. 9, the method 1100 illustrated in FIG. 11, and/or the method 1300 illustrated in FIG. 13. FIG. 15, as with the other included figures, is shown for illustrative purposes and does not limit either the possible embodiments of the present invention or the claims.

At step 1502, the controller 204 may receive an indication (e.g., from a user interface, based on one or more predetermined parameters, based on one or more sensed parameters, or the like) that the smart glass 208 is to enter a tinting mode to increase a level of tint (e.g., darken, become less transparent) or maintain a level of tinting, enter a power saving mode, or enter a tint clearing mode to decrease a level of tint (e.g., lighten, become more transparent) or clear a tint. When the controller 204 receives (e.g., in response to the controller 204 receiving) an indication that the smart glass 208 is to enter a tinting mode, at step 1504, the controller 204 may direct or communicate electrical power from the power storage device 206 to the synchronous converter 1402 via the supply rail 1405. The electrical power from the power storage device 206 may have a first voltage. At step 1506, the controller 204 may direct the synchronous converter 1402 to change a voltage of the electrical power from the first voltage to a second voltage. For example, the controller 204 may direct the power storage device 206 to provide a first voltage of about 3.0 volts to the synchronous converter 1402. The controller 204 may direct the synchronous converter 1402 to increase or step-up the first voltage to a second voltage of about 4.0 volts. As another example, the controller 204 may direct the power storage device 206 to provide a first voltage of about 6.0 volts to the synchronous converter 1402. The controller 204 may direct the synchronous converter 1402 to decrease or step-down the first voltage to the second voltage of about 4.0 volts. At step 1508, the controller 204 may modulate the first set of switches 1408a and the second set of switches 1408b so that the electrical power having the second voltage communicates to the smart glass 208 via the first electrical line 1410 and the second electrical line 1412 (e.g., but not the third electrical line 1414) to increase a level of tint of the smart glass 208 or maintain a level of tint of the smart glass 208 using the second voltage. At step 1510, the controller 204 may direct the electrical power (e.g., having zero volts or nearly zero volts) to ground or the electrical power may return to ground. For example, the controller 204 may direct the electrical power from the smart glass 208, through the third electrical line 1414, to the second set of switches 1408b, and to the ground line 1416b. As another example, the electrical power may return to ground from the smart glass 208, through the third electrical line 1414, to the second set of switches 1408b, and to the ground line 1416b.

When the controller 204 receives (e.g., in response to the controller 204 receiving) an indication that the smart glass 208 is to enter a power saving mode, at step 1512, the controller 204 may cause electrical power having a third voltage to be drawn from the smart glass 208 (the smart glass having a level of tint that is above a zero level of tint, the smart glass holding a non-zero voltage), through the second electrical line 1412, the first set of switches 1408a, and the first electrical line 1410 to the synchronous converter 1402. For example, the controller 204 may cause electrical power having a third voltage of about 1.0 volts to be drawn from the smart glass 208, through the second electrical line 1412, the first set of switches 1408a, and the first electrical line 1410 to the synchronous converter 1402. In some aspects, the controller 204 may detect that the smart glass 208 has a level of tint that is above a zero level of tint and cause electrical power having a third voltage to be drawn from the smart glass 208, through the second electrical line 1412, the first set of switches 1408a, and the first electrical line 1410 to the synchronous converter 1402 after the controller 204 modulates the first set of switches 1408a and the second set of switches 1408b so that the electrical power having the second voltage communicates to the smart glass 208 via the first electrical line 1410 and the second electrical line 1412 (e.g., but not the third electrical line 1414) to increase a level of tint of the smart glass 208 or maintain a level of tint of the smart glass 208 using the second voltage as described with respect to step 1508 and/or after the controller 204 directs the electrical power (e.g., having zero volts or nearly zero volts) from the smart glass 208, through the third electrical line 1414 and the second set of switches 1408b, to ground as described with respect to step 1510. At step 1514, the controller 204 may direct the synchronous converter 1402 to increase or step-up a voltage of the electrical power from the first electrical line 1410 from the third voltage to a fourth voltage. For example, the controller 204 may direct the synchronous converter 1402 to increase a voltage of the electrical power from the first electrical line 1410 from the third voltage of about 1.0 volts to a fourth voltage of about 6.0 volts or of about 3.0 volts depending on how much voltage is supplied from the power storage device 206 (e.g., as described in step 1106). At step 1516, the controller 204 may direct the electrical power having the fourth voltage from the synchronous converter 1402, through the supply rail 1405, to the power storage device 206 for power storage and/or power reuse.

When the controller 204 receives (e.g., in response to the controller 204 receiving) an indication that the smart glass 208 is to enter a tint clearing mode, at step 1518, the controller 204 may direct or communicate electrical power from the power storage device 206 through the supply rail 1405 to the synchronous converter 1402. The electrical power from the power storage device 206 may have a fifth voltage. In some aspects, the controller 204 may direct or communicate electrical power from the power storage device 206 through the supply rail 1405 to the synchronous converter 1402 after the controller 204 directs the electrical power having the fourth voltage from the synchronous converter 1402, through the supply rail 1405, to the power storage device 206 for power storage and/or power reuse as described with respect to step 1516. At step 1520, the controller 204 may direct or control the synchronous converter 1402 to change a voltage of the electrical power from the fifth voltage to a sixth voltage. For example, the controller 204 may direct the power storage device 206 to provide a first voltage of about 3.0 volts to the synchronous converter 1402 via the supply rail 1405. The controller 204 may direct the synchronous converter 1402 to increase or step-up the first voltage to a seventh voltage of about 4.0 volts. As another example, the controller 204 may direct the power storage device 206 to provide a sixth voltage of about 6.0 volts to the synchronous converter 1402 via the supply rail 1405. The controller 204 may direct the synchronous converter 1402 to decrease or step-down the sixth voltage to the seventh voltage of about 4.0 volts. At step 1522, the controller 204 may modulate the first set of switches 1408a and the second set of switches 1408b so that the electrical power having the seventh voltage communicates to the smart glass 208 via the first electrical line 1410 and the third electrical line 1414 (e.g., but not the second electrical line 14142) to reduce a level of tint of the smart glass 208 or clear a tint of the smart glass 208 using the seventh voltage. At step 1524, the controller 204 may direct the electrical power (e.g., having zero volts or nearly zero volts) to ground. For example, the controller 204 may direct the electrical power from the smart glass 208, through the second electrical line 1412, to the first set of switches 1408a, and to the ground line 1416a. As another example, the electrical power may return to ground from the smart glass 208, through the second electrical line 1412, to the first set of switches 1408a, and to the ground line 1416a.

Please note that the functional block(s) described herein are illustrated in FIG. 15 in merely one example arrangement. In other embodiments, the techniques and functionality described above may be performed using different steps in different orders or may be grouped into a different number of steps or may be performed as a single method without distinct steps.

A system for reusing power from a smart glass is provided. The system includes a power storage device, a synchronous converter configured to change a voltage of electrical power, a smart glass in electrical communication with the power storage device, the synchronous converter, and a controller. The smart glass is configured to change or maintain a tint in response to a voltage. The system also includes the controller. The controller is configured to receive an indication that the smart glass is to change a tint. The smart glass has a non-zero voltage between two electrical connections. The controller is also configured to change, using the synchronous converter, the voltage from the smart glass to a different voltage. The controller is further configured to apply the changed voltage to the power storage device to transfer electrical energy for storage and smart glass tinting.

In some aspects, the synchronous converter may include at least one of a boost converter, a buck converter, or a buck-boost converter. In some aspects, the system may include a power source configured to provide a voltage to change or maintain the tint of the smart glass. The controller may be further configured to control the power source to provide electrical power to the smart glass. In some aspects, the synchronous converter may be a first synchronous converter, and the system may further include a second synchronous converter. The controller may be further configured to change, using the second synchronous converter, a voltage of the electrical power before the electrical power is provided to the smart glass. In some aspects, the second synchronous converter may increase a voltage of the electrical power provided by the power source before the electrical power is provided to the smart glass. In some aspects, the second synchronous converter may include at least one of a boost convert or a buck-boost converter. In some aspects, the second synchronous converter may decrease a voltage of the electrical power provided by the power source before the electrical power is provided to the smart glass. In some aspects, the second synchronous converter may include at least one of a buck convert or a buck-boost converter.

A method for reusing power from a smart glass is provided. The method includes receiving, by a controller, an indication that the smart glass is to change a voltage. The smart glass has a non-zero voltage between two electrical connections. The method also includes changing, using the synchronous converter, the voltage from the smart glass to a different voltage. The method further includes applying the changed voltage to the power storage device to transfer electrical energy for storage and smart glass tinting. In some aspects, the synchronous converter may include at least one of a boost converter, a buck converter, or a buck-boost converter. In some aspects, the method may include controlling, by the controller, a power source to provide electrical power to the smart glass to change or maintain a tint of the smart glass. In some aspects, the synchronous converter may be a first synchronous converter. The method may further include changing, using a second synchronous converter, a voltage of the electrical power before the electrical power is provided to the smart glass. In some aspects, changing, using the second synchronous converter, the voltage of the electrical power before the electrical power is provided to the smart glass may include increasing, using the second synchronous converter, the voltage of the electrical power provided by the power source before the electrical power is provided to the smart glass. In some aspects, the second synchronous converter may include at least one of a boost convert or a buck-boost converter. In some aspects, changing, using the second synchronous converter, the voltage of the electrical power before the electrical power is provided to the smart glass may include decreasing, using the second synchronous converter, the voltage of the electrical power provided by the power source before the electrical power is provided to the smart glass. In some aspects, the second synchronous converter may include at least one of a buck convert or a buck-boost converter.

A system for reusing power from an electrochromic glass unit (EC-GU) is provided. The system includes a power storage device, a synchronous converter configured to change a voltage of electrical power, the EC-GU in electrical communication with the power source, the power storage device, the synchronous converter, and a controller. The EC-GU is configured to change or maintain a tint in response to a voltage. The system may also include the controller. The controller may be configured to receive an indication that the EC-GU is to change a tint. The EC-GU may have a non-zero voltage between to electrical connections. The controller may also be configured to change, using the synchronous converter, the voltage from the EC-GU to a different voltage. The controller may be further configured to apply the changed voltage to the power storage device to transfer electrical energy for storage and EC-GU tinting. In some aspects, the synchronous converter may include at least one of a boost converter, a buck converter, or a buck-boost converter. In some aspects, the system may further include a power source configured to provide the voltage to change or maintain the tint of the EC-GU. The controller may be further configured to control the power source to provide electrical power to the EC-GU. In some aspects, the synchronous converter may be a first synchronous converter. The system may further include a second synchronous converter. The controller may be further configured to change, using the second synchronous converter, a voltage of the electrical power before the electrical power is provided to the EC-GU.

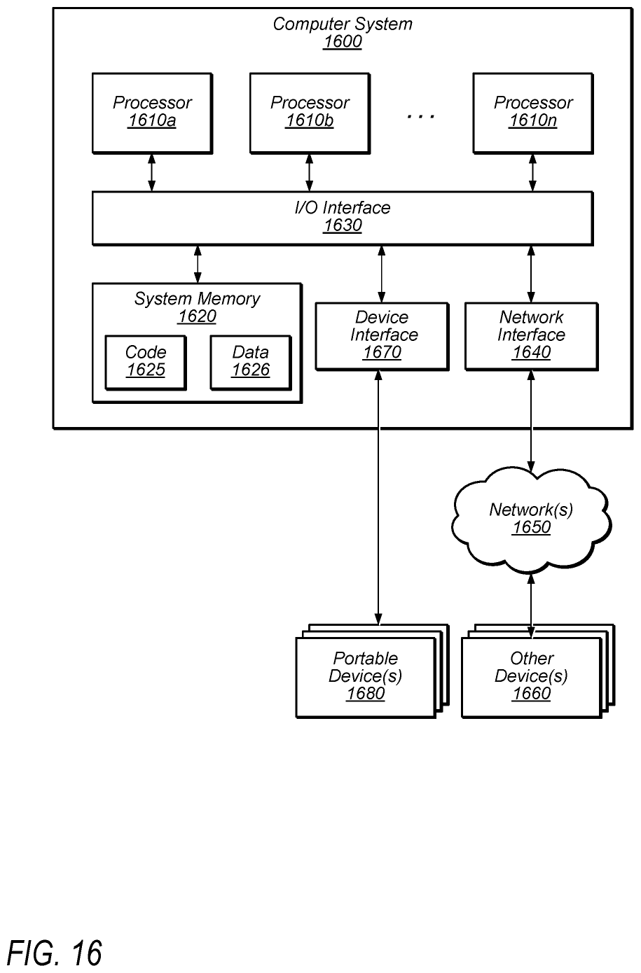

FIG. 16 illustrates an example computer system 1600 that may be used in some embodiments. The methods, features, mechanisms, techniques and/or functionality described herein may in various embodiments be implemented by any combination of hardware and software. For example, in one embodiment, the methods may be implemented by a computer system (e.g., a computer system as in FIG. 16) that includes one or more processors executing program instructions stored on a computer-readable storage medium coupled to the processors. The program instructions may implement the methods, features, mechanisms, techniques and/or functionality described herein. The various methods as illustrated in the figures and described herein represent example embodiments of methods. The order of any method may be changed, and various elements may be added, reordered, combined, omitted, modified, etc.

FIG. 16 is a block diagram illustrating a computer system 1600 according to some aspects, as well as various other systems, components, services or devices described herein. For example, computer system 1600 may implement a control unit configured to implement and/or utilize the features, methods, mechanisms and/or techniques described herein, in different embodiments. Computer system 1600 may be any of various types of devices, including, but not limited to, a personal computer system, desktop computer, laptop or notebook computer, mainframe computer system, handheld computer, workstation, network computer, a consumer device, application server, storage device, telephone, mobile telephone, embedded electronics, one or more microprocessors, one or more microcontrollers, or in general any type of computing device.

Computer system 1600 includes one or more processors 1610 (any of which may include multiple cores, which may be single or multi-threaded) coupled to a system memory 1620 via an input/output (I/O) interface 1630. Computer system 1600 further includes a network interface 1640 coupled to I/O interface 1630. In various embodiments, computer system 1600 may be a uniprocessor system including one processor 1610, or a multiprocessor system including several processors 1610 (e.g., two, four, eight, or another suitable number). Processors 1610 may be any suitable processors capable of executing instructions. For example, in various embodiments, processors 1610 may be general-purpose or embedded processors implementing any of a variety of instruction set architectures (ISAs), such as the x86, PowerPC, SPARC, or MIPS ISAs, or any other suitable ISA. In multiprocessor systems, each of processors 1610 may commonly, but not necessarily, implement the same ISA. The computer system 1600 also includes one or more network communication devices (e.g., network interface 1640) for communicating with other systems and/or components over a communications network (e.g., Internet, LAN, etc.).

For example, a control unit may receive information and/or commands from one or more other devices requesting that one or more EC devices be changed to a different tint level using the systems, methods and/or techniques described herein. For instance, a user may request a tint change via a portable remote control device (e.g., a remote control), a wall mounted (e.g., hard wired) device, or an application executing on any of various types of devices (e.g., a portable phone, smart phone, tablet and/or desktop computer are just a few examples).

In the illustrated embodiment, computer system 1600 is coupled to one or more portable storage devices 1680 via device interface 1670. In various embodiments, portable storage devices 1680 may correspond to disk drives, tape drives, solid state memory, other storage devices, or any other persistent storage device. Computer system 1600 (or a distributed application or operating system operating thereon) may store instructions and/or data in portable storage devices 1680, as desired, and may retrieve the stored instruction and/or data as needed. In some embodiments, portable device(s) 1680 may store information regarding one or EC devices, such as information regarding design parameters, etc. usable by control unit 320 when changing tint levels using the techniques described herein.

Computer system 1600 includes one or more system memories 1620 that can store instructions and data accessible by processor(s) 1610. In various embodiments, system memories 1620 may be implemented using any suitable memory technology, (e.g., one or more of cache, static random-access memory (SRAM), DRAM, RDRAM, EDO RAM, DDR 10 RAM, synchronous dynamic RAM (SDRAM), Rambus RAM, EEPROM, non-volatile/Flash-type memory, or any other type of memory). System memory 1620 may contain program instructions 1625 that are executable by processor(s) 1610 to implement the methods and techniques described herein. In various embodiments, program instructions 1625 may be encoded in platform native binary, any interpreted language such as Java™ bytecode, or in any other language such as C/C++, Java™, etc., or in any combination thereof. For example, in the illustrated embodiment, program instructions 1625 include program instructions executable to implement the functionality of a control unit, a stack voltage measurement module, an ESR module, an OCV module, a supervisory control system, local controller, project database, etc., in different embodiments. In some embodiments, program instructions 1625 may implement a control unit configured to implement and/or utilize the features, methods, mechanisms and/or techniques described herein, and/or other components.

In some embodiments, program instructions 1625 may include instructions executable to implement an operating system (not shown), which may be any of various operating systems, such as UNIX, LINUX, Solaris™, MacOS™, Windows™, etc. Any or all of program instructions 1625 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 1600 via I/O interface 1630. A non-transitory computer-readable storage medium may also include any volatile or non-volatile media such as RAM (e.g., SDRAM, DDR SDRAM, RDRAM, SRAM, etc.), ROM, etc., that may be included in some embodiments of computer system 1600 as system memory 1620 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 1640.

In one embodiment, I/O interface 1630 may coordinate I/O traffic between processor 1610, system memory 1620 and any peripheral devices in the system, including through network interface 1640 or other peripheral interfaces, such as device interface 1670. In some embodiments, I/O interface 1630 may perform any necessary protocol, timing or other data transformations to convert data signals from one component (e.g., system memory 1620) into a format suitable for use by another component (e.g., processor 1610). In some embodiments, I/O interface 1630 may include support for devices attached through various types of peripheral buses, such as a variant of the Peripheral Component Interconnect (PCI) bus standard or the Universal Serial Bus (USB) standard, for example. In some embodiments, the function of I/O interface 1630 may be split into two or more separate components, such as a north bridge and a south bridge, for example. Also, in some embodiments, some or all of the functionality of I/O interface 1630, such as an interface to system memory 1620, may be incorporated directly into processor 1610.

Network interface 1640 may allow data to be exchanged between computer system 1600 and other devices attached to a network, such as other computer systems 1660. In addition, network interface 1640 may allow communication between computer system 1600 and various I/O devices and/or remote storage devices. Input/output devices may, in some embodiments, include one or more display terminals, keyboards, keypads, touchpads, scanning devices, voice or optical recognition devices, or any other devices suitable for entering or retrieving data by one or more computer systems 1600. Multiple input/output devices may be present in computer system 1600 or may be distributed on various nodes of a distributed system that includes computer system 1600. In some embodiments, similar input/output devices may be separate from computer system 1600 and may interact with one or more nodes of a distributed system that includes computer system 1600 through a wired or wireless connection, such as over network interface 1640. Network interface 1640 may commonly support one or more wireless networking protocols (e.g., Wi-Fi/IEEE 802.11, or another wireless networking standard). However, in various embodiments, network interface 1640 may support communication via any suitable wired or wireless general data networks, such as other types of Ethernet networks, for example. Additionally, network interface 1640 may support communication via telecommunications/telephony networks such as analog voice networks or digital fiber communications networks, via storage area networks such as Fibre Channel SANs, or via any other suitable type of network and/or protocol. In various embodiments, computer system 1600 may include more, fewer, or different components than those illustrated in FIG. 16 (e.g., displays, video cards, audio cards, peripheral devices, other network interfaces such as an ATM interface, an Ethernet interface, a Frame Relay interface, etc.)

The various methods as illustrated in the figures and described herein represent example embodiments of methods. The methods may be implemented manually, in software, in hardware, or in a combination thereof. The order of any method may be changed, and various elements may be added, reordered, combined, omitted, modified, etc.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed is:

1. A system for reusing power from a smart glass, the system comprising:
a power storage device;
a synchronous converter configured to change a voltage of electrical power;
a smart glass in electrical communication with the power storage device, the synchronous converter, and a controller, wherein the smart glass is configured to change or maintain a tint in response to a voltage; and
the controller, wherein the controller is configured to:
receive an indication that the smart glass is to change a tint, wherein the smart glass has a non-zero voltage between two electrical connections,
change, using the synchronous converter, the voltage from the smart glass to a different voltage, and
apply the changed voltage to the power storage device to transfer electrical energy for storage and smart glass tinting.

2. The system of claim 1, wherein the synchronous converter comprises at least one of a boost converter, a buck converter, or a buck-boost converter.

3. The system of claim 1, further comprising a power source configured to provide a voltage to change or maintain the tint of the smart glass, wherein the controller is further configured to:
control the power source to provide electrical power to the smart glass.

4. The system of claim 3, wherein:
the synchronous converter is a first synchronous converter;
the system further comprises a second synchronous converter; and
the controller is further configured to:
change, using the second synchronous converter, a voltage of the electrical power before the electrical power is provided to the smart glass.

5. The system of claim 4, wherein the second synchronous converter increases a voltage of the electrical power provided by the power source before the electrical power is provided to the smart glass.

6. The system of claim 5, wherein the second synchronous converter comprises at least one of a boost convert or a buck-boost converter.

7. The system of claim 4, wherein the second synchronous converter decreases a voltage of the electrical power provided by the power source before the electrical power is provided to the smart glass.

8. The system of claim 7, wherein the second synchronous converter comprises at least one of a buck convert or a buck-boost converter.

9. A method for reusing power from a smart glass, the method comprising:
receive, by a controller, an indication that the smart glass is to change a voltage, wherein the smart glass has a non-zero voltage between two electrical connections;
changing, using the synchronous converter, the voltage from the smart glass to a different voltage; and
applying the changed voltage to the power storage device to transfer electrical energy for storage and smart glass tinting.

10. The method of claim 9, wherein the synchronous converter comprises at least one of a boost converter, a buck converter, or a buck-boost converter.

11. The method of claim 9, further comprising controlling, by the controller, a power source to provide electrical power to the smart glass to change or maintain a tint of the smart glass.

12. The method of claim 11, wherein:
the synchronous converter is a first synchronous converter; and
the method further comprises:
changing, using a second synchronous converter, a voltage of the electrical power before the electrical power is provided to the smart glass.

13. The method of claim 12, wherein changing, using the second synchronous converter, the voltage of the electrical power before the electrical power is provided to the smart glass comprises increasing, using the second synchronous converter, the voltage of the electrical power provided by the power source before the electrical power is provided to the smart glass.

14. The method of claim 13, wherein the second synchronous converter comprises at least one of a boost convert or a buck-boost converter.

15. The method of claim 12, wherein changing, using the second synchronous converter, the voltage of the electrical power before the electrical power is provided to the smart glass comprises decreasing, using the second synchronous converter, the voltage of the electrical power provided by the power source before the electrical power is provided to the smart glass.

16. The method of claim 15, wherein the second synchronous converter comprises at least one of a buck convert or a buck-boost converter.

17. A system for reusing power from an electrochromic glass unit (EC-GU), the system comprising:
a power storage device;
a synchronous converter configured to change a voltage of electrical power;
the EC-GU in electrical communication with the power source, the power storage device, the synchronous converter, and a controller, wherein the EC-GU is configured to change or maintain a tint in response to a voltage; and
the controller, wherein the controller is configured to:
receive an indication that the EC-GU is to change a tint, wherein the EC-GU has a non-zero voltage between to electrical connections,
change, using the synchronous converter, the voltage from the EC-GU to a different voltage, and
apply the changed voltage to the power storage device to transfer electrical energy for storage and EC-GU tinting.

18. The system of claim 17, wherein the synchronous converter comprises at least one of a boost converter, a buck converter, or a buck-boost converter.

19. The system of claim 17, further comprising a power source configured to provide the voltage to change or maintain the tint of the EC-GU, wherein the controller is further configured to:
control the power source to provide electrical power to the EC-GU.

20. The system of claim 19, wherein:
the synchronous converter is a first synchronous converter;
the system further comprises a second synchronous converter; and
the controller is further configured to:
change, using the second synchronous converter, a voltage of the electrical power before the electrical power is provided to the EC-GU.
